(19) United States
(12) Patent Application Publication
(10) Pub. No.: US 2021/0041236 A1
(43) Pub. Date: Feb. 11, 2021

(54) METHOD AND SYSTEM FOR CALIBRATION OF STRUCTURAL PARAMETERS AND CONSTRUCTION OF AFFINE COORDINATE SYSTEM OF VISION MEASUREMENT SYSTEM

(71) Applicant: China Agricultural University, Beijing (CN)

(72) Inventors: Jianlun WANG, Beijing (CN); Wensheng LIU, Beijing (CN); Chenglin ZHANG, Beijing (CN); Hongxu ZHENG, Beijing (CN); Can HE, Beijing (CN); Rina SU, Beijing (CN); Liangyu JIANG, Beijing (CN)

(21) Appl. No.: 16/969,340

(22) PCT Filed: Jul. 12, 2018
(86) PCT No.: PCT/CN2018/095337

§ 371 Date: Aug. 12, 2020

(30) Foreign Application Priority Data
Apr. 27, 2018 (CN) 201810394449.9

(51) Int. Cl. G01C 11/04; G01B 11/00; G06T 7/80

(52) U.S. Cl. CPC G01C 11/04; G06T 7/80; G01B 11/002

(57) ABSTRACT

The present application provides a method and system for calibration of structural parameters and construction of an affine coordinate system of a vision measurement system. The method comprises the following steps: S1, for the same image, performing bundle adjustment on front points and corresponding image points to acquire rear intersection point coordinates; S2, acquiring world coordinate of a front principal point corresponding to an intersection point; S3, performing the steps S1 and S2 cyclically by utilizing a plurality of different calibrated images to acquire a plurality of pairs of intersection point coordinates and world coordinates of front projection points; S4, performing tangent co-spherical second intersection adjustment by utilizing the pairs of intersection point coordinate and world coordinate of front projection point to acquire structural parameters and coordinate of rotation center of the pan-tilt of the vision measurement system; and S5, establishing an affine space coordinate system. By adopting a co-spherical second intersection iteration calibration method, structural parameters of a vision measurement system (that is, a pan-tilt and lens camera system and a hand-eye system) can be accurately calibrated, an accurate affine coordinate system is established, and uncalibrated accurate measurement of the vision measurement system is achieved based on its own structural parameters of the vision measurement system.

### CROSS-REFERENCE TO RELATED APPLICATION

The present application claims priority to Chinese Application No. 201810394449.9 filed on Apr. 27, 2018, entitled “Method and System for Calibration of Structural Parameters and Construction of Affine Coordinate System of Vision Measurement System”, the disclosure of which is hereby incorporated by reference in its entirety.

### FIELD OF TECHNOLOGY

The present application relates to the field of digital photogrammetry technologies, and more particularly, to a method and system of calibration of structural parameters and construction of an affine coordinate system of a vision measurement system.

### BACKGROUND

With the rapid development of modern system integration technology and agricultural information acquisition technology in the field of precision agriculture, it has enabled agriculture and other social industries to put forward higher requirements for related phenotypic measurements, operating mechanical quantity detection, geometric quantity detection, structure test and so on, such as high-throughput, uncalibrated, non-contact, cheap, high-precision and networked, etc.

Since the vision measurement system can meet the requirements above to a certain extent, a digital photogrammetry method in combination with digital image analysis has been widely used in three-dimensional measurement so far. Wherein, the two-axis turntable-lens-camera integrated system (hereinafter referred to as pan-tilt and lens camera system or hand-eye-like system) is a vision measurement system constructed by non-measurement equipment, which has been widely used in industry, architecture and biomedicine. As a photogrammetry instrument for field environment in agricultural and other industry operations, it can easily and cheaply acquire digital images of objects within the field of view, and can perform analysis and uncalibrated three-dimensional measurement operations.

The key to the analysis and the uncalibrated three-dimensional measurement operation of the vision measurement system is the establishment of the affine coordinate system of the pan-tilt and lens camera, while the calculation of rotation center coordinate of the pan-tilt integrated with camera and lens and integrated structural parameters is the base on which the affine coordinate system of the pan-tilt and lens camera is accurately established. At present, with respect to the calibration of two-degree-of-freedom hand-eye system, due to the collinear intersection adjustment method used in the parameter calculation process, only the world coordinate of the focal point can be acquired, by way of which is not enough to further accurately calculate the structural parameters of the hand-eye system. Moreover, the calibration accuracy cannot be controlled by directly acquiring the parameters often using the motion structure vector, which results in the affine relationship of the hand-eye coordinate system cannot be accurately calibrated, thereby affecting the accuracy of vision measurement. Thus, control points, structured light and laser are generally used to assist in improving accuracy. Nonetheless, unsatisfactory correction by the control points, structured light, and laser assisted method may lead to inaccurate calibration of the affine relationship of the hand-eye coordinate system, which affects the precision of vision measurement.

### SUMMARY

In order to overcome or at least partially solve the problems above, the present application provides a method and a system for calibration of structural parameters and construction of an affine coordinate system of a vision measurement system so as to effectively improve the parameter calibration precision of the target vision measurement system motion structure, thereby more precisely representing the affine relationship of the target vision measurement system, improving the vision measurement precision, and thus realizing the uncalibrated precise measurement based on its own structural parameters of the vision measurement system.

On the one hand, the present application provides a method for calibration of structural parameters and construction of an affine coordinate system of a vision measurement system, comprising: S1, acquiring intersection point coordinates through a bundle adjustment collinear resection; S2, acquiring world coordinate of a front projection point of a principal point corresponding to the intersection point coordinates; S3, performing the steps S1 and S2 cyclically by utilizing a plurality of different calibrated images to acquire a plurality of pairs of intersection point coordinates and world coordinates of the front projection points; S4, based on the plurality of pairs of intersection point coordinates and world coordinates of the front projection points, performing bundle adjustment tangent co-spherical second intersection, and acquiring coordinate of rotation center of the pan-tilt and structural parameters of the vision measurement system through iterative operations; and S5, based on the coordinate of rotation center of the pan-tilt and structural parameters, establishing an affine space coordinate system on the basis of the rotation center of the pan-tilt.

On the other hand, the present application provides a system for calibration of structural parameters and construction of an affine coordinate system of a vision measurement system, comprising: a first intersection operation module configured to acquire intersection point coordinates through a bundle adjustment collinear resection; a front projection point world coordinate calculation module configured to acquire world coordinate of a front projection point of a principal point corresponding to the intersection point coordinates; a multiple point pair acquisition module configured to control the first intersection operation module and the front projection point world coordinate calculation module to acquire a plurality of pairs of intersection point coordinates and world coordinates of front projection points according to a plurality of different calibrated images; a second intersection operation module configured to perform a bundle adjustment tangent co-spherical second intersection based on the plurality of pairs of intersection point coordinates and world coordinates of the front projection points, and acquire coordinate of rotation center of the pan-tilt and structural parameters of the vision measurement system through iterative operations; and an affine space coordinate system construction module configured to establish an affine space coordinate system on the basis of the rotation center of the pan-tilt, based on the coordinate of rotation center of the pan-tilt and the structural parameters.

The present application provides a method and a system for calibration of structural parameters and construction of an affine coordinate system of a vision measurement system acquires a plurality of intersection point coordinates and the world coordinates of corresponding front principal points according to the bundle adjustment collinear intersection, performs bundle adjustment tangent co-spherical second intersection in the light of the intersection point coordinates and world coordinates of the front principal points, solves the structural parameters of the vision measurement system and coordinate of the rotation center of the pan-tilt, and constructs the affine coordinate system of the vision measurement system on this basis, which can effectively improve the precision of parameter calibration of the motion structure of the target vision measurement system, thereby more precisely representing the affine relationship of the target vision measurement system, and improving the vision measurement precision.

### BRIEF DESCRIPTION OF THE DRAWINGS

FIG. 1 is a flowchart of a method for calibration of structural parameters and construction of an affine coordinate system of a vision measurement system according to an embodiment of the present application;

FIG. 2 is a cross-sectional view of a two-degree-of-freedom hand-eye motion structural parameters calibration and affine coordinate system in the method for calibration of structural parameters and construction of an affine coordinate system of a vision measurement system according to an embodiment of the present application;

FIG. 3 is a three-dimensional structural diagram of a two-degree-of-freedom hand-eye motion structural parameters calibration and affine coordinate system in the method for calibration of structural parameters and construction of an affine coordinate system of a vision measurement system according to an embodiment of the present application;

FIG. 4 is a structural diagram of a system for calibration of structural parameters and construction of an affine coordinate system of a vision measurement system according to an embodiment of the present application; and

FIG. 5 is a structural block diagram of a device for calibration of structural parameters and construction of an affine coordinate system of a vision measurement system according to an embodiment of the present application.

### DETAILED DESCRIPTION

In order to make the objectives, technical solutions and advantages of the present application clearer, the technical solutions in the present application will be described clearly and completely in conjunction with the drawings in the embodiments of the present application. Obviously, the embodiments described below are part of embodiments, rather than all the embodiments. Based on the embodiments in the present application, all other embodiments acquired by a person of ordinary skill in the art without creative efforts shall fall within the protection scope of the present application.

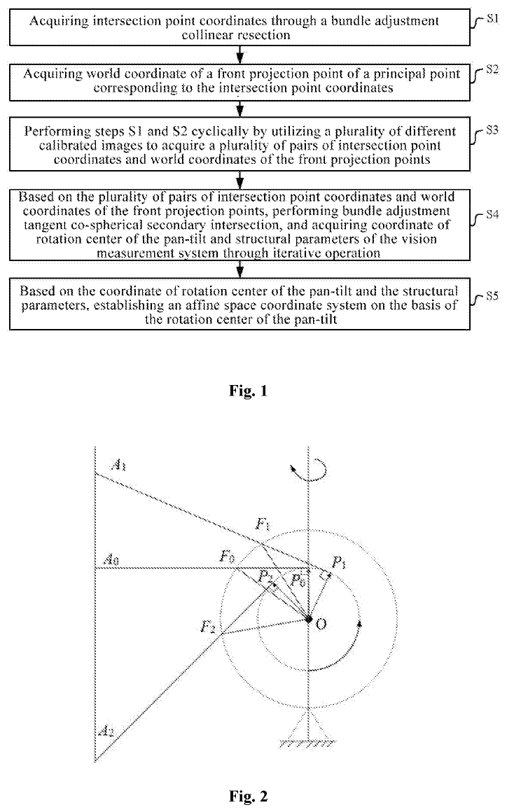

As an aspect of the embodiments of the present application, the present embodiment provides a method for calibration of structural parameters and construction of an affine coordinate system of a vision measurement system. Referring to FIG. 1, it shows a flowchart of the method for calibration of structural parameters and construction of an affine coordinate system of the vision measurement system according to the embodiment of the present application, comprising:

S1, acquiring intersection point coordinates through a bundle adjustment collinear resection.

It can be understood that in this step, through a bundle adjustment collinear resection, the rear collinearity condition equations are written, and the coordinates of the intersection points corresponding to each image, namely the focal coordinates of the first intersection are calculated by the adjustment algorithm.

Wherein, for each calibrated image, based on a plurality of image points on the calibrated image and the front principal point corresponding to the corresponding image point, the bundle collinear resection is performed, and the coordinates of the intersection point, namely the focal point coordinates of the first intersection, are acquired through the iterative operation of bundle adjustment corrected based on a weight matrix of observed values. Wherein the front principal point is a front control calibration point.

That is, for each calibrated image, a plurality of image points and corresponding front principal points corresponding to respective image points are selected to perform bundle adjustment collinear resection calculation, to acquire the intersection point coordinate of the resection point corresponding to the image. That is, for the same frame image, using the collinear relationship between the front principal points, the corresponding image points and the resection points, a collinear equation is written to perform the bundle collinear resection calculation. The weight matrix of the observed values is then adopted to correct the bundle adjustment calculation process, and iterative results that meet the set standard are acquired as the final coordinate of the resection point through the iterative operation of bundle adjustment.

S2, acquiring world coordinates of front projection points of principal points corresponding to the intersection point coordinates.

It can be understood that in this step, according to the optical characteristics of the front principal point, based on the coordinate of the intersection point acquired from the specific calibrated image in the above step and the principal optical axis acquired at the same time, the world coordinate of the target projection of the front principal point corresponding to the intersection point along the principal optical axis are acquired.

S3, performing steps S1 and S2 cyclically by utilizing a plurality of different calibrated images to acquire a plurality of pairs of intersection point coordinates and world coordinates of the front projection points.

It can be understood that, in the parameter calibration of the target vision measurement system, the observation of front principal point for only one calibrated image will introduce great errors or even mistakes. Therefore, it is necessary to use the target vision measurement system to observe multiple corresponding points in multiple calibrated images separately, and then the bundle intersection calculation is applied to acquire more accurate coordinate of the resection point of the calibrated image, and the world coordinate of the front principal point corresponding to the intersection point coordinate.

That is, iterative intersection of multiple pairs of points is required to acquire more accurate spherical center coordinate and structural parameters, and the observation of front principal point on multiple calibrated images with different orientations is needed.

For the multiple calibrated images observed by the target vision measurement system, the coordinates of the intersection points are acquired successively through the bundle adjustment collinear resection respectively, and the world coordinates of the front principal points corresponding to the intersection point coordinates are solved using the optical characteristics of the principal point.

Optionally, the step of S3 further includes: traversing all the calibrated images, performing steps S1 and S2 cyclically, acquiring an F(X_{f}, Y_{f}, Z_{f}) point set of the intersection point coordinates, and the corresponding world coordinate A(X, Y, Z) of the front projection point in which systematic errors are corrected.

It can be understood that, according to the optical characteristics of the front principal point, the world coordinates of the front principal point corresponding to the coordinates of the first intersection point of the captured calibrated image of each position are calculated respectively, and correction of systematic errors is performed on the world coordinates.

Wherein, each image in multiple images is traversed. For each image traversed, first, the rear collinear condition equation is written through the bundle collinear resection, and the adjustment algorithm is applied to calculate the intersection point coordinates corresponding to each image. Then, according to the optical characteristics of the front principal point, the world coordinates of the front principal point corresponding to the acquired intersection point coordinates are solved.

S4, based on the plurality of pairs of intersection point coordinates and world coordinates of the front projection points, performing bundle adjustment tangent co-spherical second intersection, and acquiring coordinate of rotation center of the pan-tilt and structure parameters of the vision measurement system through iterative operations.

It can be understood that, after the coordinates of the resection point corresponding to the multi-frame calibrated images and the world coordinates of the corresponding front principal points are acquired through the bundle adjustment collinear resection according to the above steps, the bundle adjustment co-spherical second intersection is performed using the coordinates of the resection point corresponding to the multi-frame images and the corresponding world coordinates of the front principal point.

To be specific, the intersection point coordinates F and the world coordinates A of the front principal point form a straight line, which is tangent to the vector sphere of the rotation vector P, and the tangent point is P. Based on multiple calibrated images, multiple tangent lines are established, and tangent co-spherical condition equations are written, and then bundle adjustment tangent co-spherical intersection is performed to acquire the structural parameters and the world coordinate of the rotation center of the pan-tilt of the target vision measurement system.

That is, based on the intersection point coordinates corresponding to each calibrated image and the world coordinates of the front principal points, the structural parameters and the world coordinate of the rotation center of the pan-tilt of the target vision measurement system are acquired through iterative operation of the bundle adjustment co-spherical intersection.

S5, based on the coordinate of the rotation center of the pan-tilt and the structure parameters, establishing an affine space coordinate system on the basis of the rotation center of the pan-tilt.

It can be understood that after completing the calibration of the structural parameters and the rotation center of the pan-tilt of the target vision measurement system according to the above steps, the affine coordinate system under different angle of views of the target vision measurement system is constructed according to the calibrated structural parameters and the rotation center of the pan-tilt. For example, with the calibrated rotation center of the pan-tilt as the coordinate origin, the pan-tilt is continuously rotated to sequentially reach each required angle of view, and an affine coordinate system is constructed according to the structural parameters of the target vision measurement system under each angle of view sequentially.

The embodiment of present application provides a method for calibration of structural parameters and construction of an affine coordinate system of a vision measurement system, which acquires a plurality of intersection point coordinates and the corresponding world coordinates of the front principal point according to the bundle adjustment collinear intersection, performs bundle adjustment tangent co-spherical second intersection in the light of the intersection point coordinates and world coordinates of the front principal point, solves the structural parameters of the vision measurement system and the coordinate of rotation center of the pan-tilt, and constructs the affine coordinate system of the vision measurement system on this basis. The method can effectively improve the precision of parameter calibration of the motion structure of the target vision measurement system, thereby more precisely representing the affine relationship of the target vision measurement system, improving the vision measurement precision, and thus achieving the uncalibrated accurate measurement based on the vision measurement system's own structural parameters.

Wherein, in one embodiment, the step of S1 further includes: establishing a collinear condition equation for a group of corresponding projection points on the two planes of a calibration board and a calibrated image, performing bundle adjustment calculation, and acquiring intersection point coordinate F(X_{f}, Y_{f}, Z_{f});

the normal equation is:

(A₁^{T}WA₁₎X₁=A₁^{T}WL₁;

then the solution of the normal equation is:

X₁₌₍A₁^{T}WA₁)⁻¹A₁^{T}WL₁;

in the equation, W is an observation-value weight matrix configured to introduce correction of systematic errors;

W=[(c₁₁X+c₁₂), (c₂₁Y+c₂₂), (c₃₁Z+c₃₂)];

through iterative operation, acquiring the intersection point coordinate F(X_{f}, Y_{f}, Z_{f}) in which systematic errors are corrected.

Wherein, according to the equipment conditions of the actual calibration experiment, the initial values (X_{f}⁰, Y_{f}⁰, Z_{f}⁰) of the coordinates of the front points of the bundle collinear resection are estimated;

the normal equation of the adjustment operation is corrected using the observation-value weight matrix as follows:

(A₁^{T}WA₁)X₁=A₁^{T}WL₁;

in the equation, A₁ is a first observation matrix, Wis an observation-value weight matrix that introduces error correction components W=[(c₁₁X+c₁₂), (c₂₁Y+c₂₂), (c₃₁Z+c₃₂)], wherein X, Y, Z represent the parametric variables in an image space of the collinear condition equation in the calculation of the bundle collinear resection, c₁₁, c₁₂, c₂₁, c₂₂, c₃₁ and c₃₂ represent correction coefficients, X₁ is an incremental vector of external orientation element, and L₁ is a linearized transformation vector of the constant item of the error equation;

the normal equation corrected by the observation-value weight matrix is solved, and the incremental vector of the external orientation element is acquired as follows:

X₁=(A₁^{T}WA₁)⁻¹A₁^{T}WL₁;

with the three angular elements in the incremental vectors of the external orientation element as increments of the intersection point coordinates, and based on the initial values X_{f}^{O}, Y_{f}⁰, Z_{f}⁰) of the intersection point coordinates and increments of the intersection point coordinates, iterative operation of the coordinates is performed to acquire the intersection point coordinate F(X_{f}, Y_{f}, Z_{f}).

It should be understood that in the embodiment, for each image, a collinear condition equation for a group of corresponding projection points is established on the two planes of a calibration board and a calibrated image, bundle adjustment calculation is performed, and intersection point coordinate F(X_{f}, Y_{f}, Z_{f}) are acquired.

Specifically, before the collinear intersection is performed, according to the equipment conditions of the actual calibration experiment, the initial values (X_{f}⁰, Y_{f}⁰, Z_{f}⁰) of the intersection point coordinates of the bundle collinear resection are estimated, bundle adjustment calculation is performed after the collinear condition equation is written according to the existing bundle collinear resection operation, and the error equation of the bundle adjustment is as follows:

V₁=A₁X₁−L;

wherein

$${V}_{1} = {[ {v}_{1 x} , {v}_{1 y} ]}^{T} , {L}_{1} = {[ {l}_{1 x} , {l}_{1 y} ]}^{T} , {X}_{1} = {[ {dX}_{f} {dY}_{f} {dZ}_{f} d ϕ d ω d κ ]}^{T} , \\ {A}_{1} = [ \begin{matrix}{a}_{11} & {a}_{12} & {a}_{13} & {a}_{14} & {a}_{15} & {a}_{16} \\ {a}_{21} & {a}_{22} & {a}_{23} & {a}_{24} & {a}_{25} & {a}_{26}\end{matrix} ] .$$

Wherein

$${v}_{1 x} = {a}_{11} d {X}_{f} + {a}_{12} d {Y}_{f} + {a}_{13} d {Z}_{f} + {a}_{14} d ϕ + {a}_{15} d ω + {a}_{16} d κ - {l}_{1 x} ;$$

$${v}_{1 y} = {a}_{21} d {X}_{f} + {a}_{22} d {Y}_{f} + {a}_{23} d {Z}_{f} + {a}_{24} d ϕ + {a}_{25} d ω + {a}_{26} d κ - {l}_{1 y} ;$$

$$\begin{matrix}{l}_{1 x} = x - ( x ) \\ = x + f \frac{{a}_{1} ( X - {X}_{f} ) + {b}_{1} ( Y - {Y}_{f} ) + {c}_{1} ( Z - {Z}_{f} )}{{a}_{3} ( X - {X}_{f} ) + {b}_{3} ( Y - {Y}_{f} ) + {c}_{3} ( Z - {Z}_{f} )} ;\end{matrix}$$

$$\begin{matrix}{l}_{1 y} = y - ( y ) \\ = y + f \frac{{a}_{2} ( X - {X}_{f} ) + {b}_{2} ( Y - {Y}_{f} ) + {c}_{2} ( Z - {Z}_{f} )}{{a}_{3} ( X - {X}_{f} ) + {b}_{3} ( Y - {Y}_{f} ) + {c}_{3} ( Z - {Z}_{f} )} .\end{matrix}$$

Simultaneously, the normal equation of the bundle adjustment is determined as follows:

(A₁^{T}WA₁)X₁=A₁^{T}WL₁;

in the equation, A₁ is a first observation matrix, W is an observation-value weight matrix that introduces error correction components W=[(c₁₁X+c₁₂), (c₂₁Y+c₂₂), (c₃₁Z+c₃₂)], wherein X, Y, Z represent parametric variables of the collinear condition equation in the calculation of the bundle collinear resection, c₁₁, c₁₂, c₂₁, c₂₂, c₃₁ and c₃₂ represent correction coefficients, Xi is an incremental vector of the external orientation elements, and L₁ is a linearized transformation vector of the collinear condition equation.

Then, solving the solution of the above normal equation, that is, the incremental vector of the external orientation element is acquired as:

X₁=A₁^{T}WA₁)⁻¹A₁^{T}W:₁

Wherein, the three angular element components in the incremental vector X₁ of the external orientation element correspond to the three coordinate component increments of the intersection coordinate.

It should be understood that for each image, a group of corresponding incremental data of the intersection coordinates can be acquired according to the above processing steps. After determining the initial values (X_{f}⁰, Y_{f}⁰, Z_{f}⁰) of the intersection point coordinates of the bundle collinear resection and the incremental data (dX_{f}, dY_{f}, dZ_{f}) of the intersection point coordinates corresponding to each image according to the above processing steps, iterative operation is performed according to a given iterative formula to get the intersection point coordinate F(X_{f}, Y_{f}, Z_{f}) in which the systematic errors are corrected.

Wherein, in the light of the embodiment above, the step of S2 further includes: based on the intersection point coordinates, correcting the coordinates of the calibrated image of the principle point by means of the observation-value weight matrix W for correction of optical distortion, and utilizing the optical characteristics of the principle points to solve the world coordinates of the principle points on the calibration board according to the corrected coordinates of the calibrated image of the principle point, and acquiring world coordinates of the front projection points.

It can be understood that, in an ideal state, the principal point in the image at the moment of acquisition, the front projection point thereof along the principal optical axis and the first intersection point are three collinear, and each front projection principal point and each principal point in the image are in one-to-one correspondence. Therefore, after the image space coordinates of the principal points in the image are known, the world coordinates of the projection points of the calibration board in front of the principal points can be approximatively acquired according to the optical characteristics of the principal optical axis.

Considering observation errors of the image point coordinates in the image, before acquiring the world coordinates of the front principal points, the observation-value weight matrix in the above embodiment is applied to make corrections during the process of acquiring the world coordinates of the front principal points, and then the corrected world coordinates of the front principal points are acquired. It should be understood that the observation-value weight matrix is configured to correct the optical distortion.

That is, for the image coordinates of any image point involved in the calculation, the initial image coordinates are corrected using the observation-value weight matrix, and then the world coordinates of the front principal points are calculated and acquired; wherein the observation-value weight matrix is configured to correct optical distortion.

Wherein, in an embodiment, the step of S4 further includes:

taking each pair of corresponding points in the F(X_{f}, Y_{f}, Z_{f}) point set of the intersection point coordinates and the world coordinate A(X, Y, Z) point set of the front projection points acquired in one intersection as a group of corresponding projection points, establishing a tangent co-spherical condition equation with each pair of the points corresponding to a corresponding point in the space point set P; F(X_{f}, Y_{f}, Z_{f}) and P are each a co-spherical point set, a straight line AFP is the tangent line of a sphere P with P being the tangent point; performing co-spherical second intersection on A, F and P, and acquiring world coordinate O(X_{O}, Y_{O}, Z_{O}) of the intersection point of the rotation center, meanwhile solving structure parameters d_{zo} and R;

acquiring a corresponding vector \vec{(OP)ᵢ} of each Fᵢ in F(X_{f}, Y_{f}, Z_{f}) by the rotation of vector \vec{OP}, and a rotation matrix from \vec{OP}to \vec{OPᵢ} being

$$[ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] ;$$

the tangent equation of the three points A, F and P is:

$$\frac{X - {X}_{p}}{{X}_{f} - {X}_{p}} = \frac{Y - {Y}_{p}}{{Y}_{f} - {Y}_{p}} = \frac{Z - {Z}_{p}}{{Z}_{f} - {Z}_{p}} = \frac{1}{λ} ;$$

the solution is:

$${X}_{f} = \frac{( X - {X}_{o} - {a}_{2} \cdot R )}{Z - {Z}_{o} - {c}_{2} \cdot R} \cdot {d}_{z 0} \cdot {c}_{3} + {X}_{o} + {a}_{2} \cdot R ;$$

$${Y}_{f} = \frac{( Y - {Y}_{o} - {a}_{2} \cdot . R )}{Z - {Z}_{o} - {c}_{2} \cdot R} \cdot {d}_{z 0} \cdot {c}_{3} + {Y}_{o} + {a}_{2} \cdot R ;$$

wherein X_{f}, Y_{f}, Z_{f} are components of the intersection point coordinate of the bundle adjustment collinear resection, (X_{O}, Y_{O}, Z_{O}) is the intersection point coordinate of the bundle adjustment co-spherical intersection, that is, world coordinate of the rotation center of the pan-tilt, d_{z0} and R are the structural parameters of the target vision measurement system;

the error equation is:

V₂=A₂X₂−L₂;

wherein:

$${V}_{2} = {[ {v}_{x} , {v}_{y} ]}^{T} ;$$

$${v}_{x} = {a}_{11} {dX}_{o} + {a}_{12} {dY}_{o} + {a}_{13} {dZ}_{o} + {a}_{14} d ( {d}_{z 0} ) + {a}_{15} dR - {l}_{x} ;$$

$${v}_{y} = {a}_{21} {dX}_{o} + {a}_{22} {dY}_{o} + {a}_{23} {dZ}_{o} + {a}_{24} d ( {d}_{z 0} ) + {a}_{25} dR - {l}_{y} ;$$

$${L}_{2} = {[ {l}_{x} , {l}_{y} ]}^{T} ;$$

$$\begin{matrix}{l}_{x} = {X}_{f} - ( {X}_{f} ) \\ = X + \frac{( X - {X}_{o} - {a}_{2} \cdot R )}{Z - {Z}_{o} - {c}_{2} \cdot R} \cdot {d}_{z 0} \cdot {c}_{3} + {X}_{O} + {a}_{2} \cdot R ;\end{matrix}$$

$$\begin{matrix}{l}_{y} = {Y}_{f} - ( {Y}_{f} ) \\ = Y + \frac{( Y - {Y}_{o} - {a}_{2} \cdot R )}{Z - {Z}_{o} - {c}_{2} \cdot R} \cdot {d}_{z 0} \cdot {c}_{3} + {Y}_{O} + {a}_{2} \cdot R ;\end{matrix}$$

$${A}_{2} = [ \begin{matrix}{a}_{11} & {a}_{12} & {a}_{13} & {a}_{14} & {a}_{15} \\ {a}_{21} & {a}_{22} & {a}_{23} & {a}_{24} & {a}_{25}\end{matrix} ] ;$$

$${X}_{2} = {[ {dX}_{o} {dY}_{o} {dZ}_{o} d ( {d}_{z 0} ) dR ]}^{T} ;$$

the normal equation is:

(A₂^{T}WA₂)X₂=A₂^{T}WL₂;

the solution to the normal equation is:

X₂=(A₂^{T}WA₂)⁻¹A₂^{T}WL₂;

in the equation, A₂ is a second observation matrix, W is an observation-value weight matrix that introduces error correction components, W=[c₁₁X+c₁₂), (c₂₁Y+c₂₂), (c₃₁Z+c₃₂)], wherein X, Y, Z represent the parametric variables of the front principal point of the tangent condition equation in the calculation of bundle tangent co-spherical intersection, c₁₁, c₁₂, c₂₁, c₂₂, c₃₁ and c₃₂ represent compensation coefficients, X₂ is an incremental vector of the rotation center coordinate and the structural parameters, and L₂ is the linearized transformation vector of the tangent co-spherical condition equation;

$$W = [ ( {c}_{11} X + {c}_{12} ) , ( {c}_{21} Y + {c}_{22} ) , ( {c}_{31} Z + {c}_{32} ) ] ;$$

the items in

$${A}_{2} = [ \begin{matrix}{a}_{11} & {a}_{12} & {a}_{13} & {a}_{14} & {a}_{15} \\ {a}_{21} & {a}_{22} & {a}_{23} & {a}_{24} & {a}_{25}\end{matrix} ]$$

are:

$$\begin{matrix}{a}_{11} = - \frac{{\partial }_{{X}_{f}}}{{\partial }_{{X}_{o}}} \\ = - \frac{{d}_{z 0} \cdot {c}_{3}}{Z - {Z}_{o} - {c}_{2} \cdot R} + 1 ;\end{matrix}$$

$${a}_{12} = - \frac{{\partial }_{{X}_{f}}}{{\partial }_{{Y}_{o}}} = 0 ;$$

$$\begin{matrix}{a}_{13} = - \frac{{\partial }_{{X}_{f}}}{{\partial }_{{Z}_{o}}} \\ = - ( X - {X}_{o} - {a}_{2} \cdot R ) \cdot ( {d}_{z 0} \cdot {c}_{3} ) \cdot \frac{1}{{( Z - {Z}_{o} - {c}_{2} \cdot R )}^{2}} ;\end{matrix}$$

$$\begin{matrix}{a}_{14} = - \frac{{\partial }_{{X}_{f}}}{{\partial }_{R}} \\ = \frac{\begin{matrix}{a}_{2} \cdot {d}_{z 0} \cdot {c}_{3} \cdot ( Z - {Z}_{o} - {c}_{2} \cdot R ) - {c}_{2} \cdot {d}_{z 0} \cdot {c}_{3} \cdot \\ ( X - {X}_{o} - {a}_{2} \cdot R )\end{matrix}}{{( Z - {Z}_{o} - {c}_{2} \cdot R )}^{2}} + a 2 ;\end{matrix}$$

$$\begin{matrix}{a}_{15} = - \frac{{\partial }_{{X}_{f}}}{{\partial }_{{d}_{z 0}}} \\ = - {c}_{3} \cdot \frac{X - {X}_{o} - {a}_{2} \cdot R}{Z - {Z}_{o} - {c}_{2} \cdot R} ;\end{matrix}$$

$${a}_{21} = - \frac{{\partial }_{{Y}_{f}}}{{\partial }_{{X}_{o}}} = 0 ;$$

$$\begin{matrix}{a}_{22} = - \frac{{\partial }_{{Y}_{f}}}{{\partial }_{{Y}_{o}}} \\ = - \frac{{d}_{z 0} \cdot {c}_{3}}{Z - {Z}_{o} - {c}_{2} \cdot R} + 1 ;\end{matrix}$$

$$\begin{matrix}{a}_{23} = - \frac{{\partial }_{{Y}_{f}}}{{\partial }_{{Z}_{o}}} \\ = - ( Y - {Y}_{o} - {a}_{2} \cdot R ) \cdot ( {d}_{z 0} \cdot {c}_{3} ) \cdot \frac{1}{{( Z - {Z}_{o} - {c}_{2} \cdot R )}^{2}} ;\end{matrix}$$

$$\begin{matrix}{a}_{24} = - \frac{{\partial }_{{Y}_{f}}}{{\partial }_{R}} \\ = \frac{\begin{matrix}{b}_{2} \cdot {d}_{z 0} \cdot {c}_{3} \cdot ( Z - {Z}_{o} - {c}_{2} \cdot R ) - {c}_{2} \cdot {d}_{z 0} \cdot {c}_{3} \cdot \\ ( X - {X}_{o} - {a}_{2} \cdot R )\end{matrix}}{{( Z - {Z}_{o} - {c}_{2} \cdot R )}^{2}} + b 2 ;\end{matrix}$$

$$\begin{matrix}{a}_{25} = - \frac{{\partial }_{{Y}_{f}}}{{\partial }_{{d}_{z 0}}} \\ = - {c}_{3} \cdot \frac{Y - {Y}_{o} - {a}_{2} \cdot R}{Z - {Z}_{o} - {c}_{2} \cdot R} ;\end{matrix}$$

through iterative operation, acquiring the world coordinate O(X_{O}, Y_{O}, Z_{O}) of the intersection point of the rotation center in which systematic errors are corrected, and the structural parameters d_{z0} and R;

wherein, the calculation process of performing the co-spherical second intersection and iterative operation includes:

establishing a world coordinate system of a two-dimensional calibration board, acquiring image coordinates of the principal points from an image plane, and performing systematic error correction on the image point coordinates using the matrix W;

calculating the world coordinates of the projected points of the principal points on the calibration board using the image coordinates of the principal points;

roughly estimating initial values X_{O}⁰, Y_{O}⁰, Z_{O}⁰, and R⁰ based on the equipment conditions of the actual calibration experiment;

substituting the values of the three angular elements with external orientation element acquired from the first collinear intersection;

calculating approximate values of each point in the F(X_{f}, Y_{f}, Z_{f}) point set point by point;

calculating corrected numerical values dX_{O}, dY_{O}, dZ_{O} of spherical center coordinate and corrected numerical values d(d_{zo}) and dR of structural parameters point by point;

calculating the value of the current iteration by adding approximate values at the previous iteration to the corrected numerical values:

X_{O}ⁱ=X_{O}ⁱ⁻¹+dX_{O}ⁱ; Y_{O}ⁱ=Y_{O}ⁱ⁻¹+DY_{O}ⁱ; Z_{O}ⁱ=Z_{O}ⁱ⁻¹+dZ_{O}ⁱ; d_{z0}ⁱ=d_{z0}ⁱ⁻¹+d(d_{zo}ⁱ); Rⁱ=Rⁱ⁻¹+dRⁱ;

comparing the corrected numerical values dX_{O}, dY_{O}, dZ_{O} of the calculated spherical center coordinate and the corrected numerical values d(d_{zo}) and dR of the calculated structural parameters with a predetermined tolerance, allowing the iteration to end if a precision is reached, and then outputting the spherical center coordinate O(X_{O}, Y_{O}, Z_{O}) and the structural parameters d_{zo} and R.

It can be understood that, based on the intersection point coordinates F, world coordinates A of the front principal points, and the spatial point P corresponding to each calibrated image, the tangent co-spherical condition equations are established respectively;

the rotation center O of the pan-tilt is taken as the coordinate origin, according to the correspondence between the intersection point coordinate F and the rotation vector \vec{(OP)ᵢ} of the vector \vec{OP}, the tangent co-spherical condition equation is solved to acquire coordinate solution of the intersection point with respect to the structural parameters and the world coordinate of the rotation center of the pan-tilt of the target vision measurement system;

with the error equation being written, the normal equation of the tangent co-spherical intersection adjustment operation is corrected using the observation-value weight matrix as follows:

(A₂^{T}WA₂)X₂=A₂^{T}WL₂;

in the equation, A₂ is a second observation matrix, W is an observation-value weight matrix that introduces error correction components, W=[c₁₁X+c₁₂), (c₂₁Y+c₂₂), (c₃₁Z+c₃₂)], wherein X, Y, Z represent the parametric variables in an image space of the tangent condition equation in the calculation of bundle tangent co-spherical intersection, c₁₁, c₁₂, c₂₁, c₂₂, c₃₁ and c₃₂ represent the compensation coefficients, X₂ is an incremental vector of the coordinate of rotation center and structural parameters, and L₂ is the linearized transformation vector of the tangent co-spherical condition equation;

as the normal equation corrected by the observation-value weight matrix is solved, the incremental vector of the coordinate of rotation center and of structural parameters is acquired as follows:

X₂=(A₂^{T}WA₂)⁻¹A₂^{T}WL₂;

based on the coordinate solution of the intersection point with respect to the structural parameters and the world coordinate of the rotation center of the pan-tilt of the target vision measurement system, the error equation, and the incremental vector of the coordinate of rotation center and the structural parameters, iterative operation is performed to acquire the structural parameters and the world coordinate of the rotation center of the pan-tilt of the target vision measurement system.

Referring to FIG. 2, it shows a cross-sectional view of calibration of structural parameters and an affine coordinate system of a two-degree-of-freedom hand-eye motion structure in the method for calibration of structural parameters and construction of an affine coordinate system of a vision measurement system according to the embodiment of the present application. The intersection point set F(X_{f}, Y_{f}, Z_{f}) and the front principal point set A(X, Y, Z) acquired from the bundle adjustment collinear resection are a group of corresponding projection points, which respectively correspond to space points P(Xₚ, Yₚ, Zₚ) in pairs. Since F(X_{f}, Y_{f}, Z_{f}) and P(Xₚ, Yₚ, Zₚ) are each a group of co-spherical point set, the straight line AFP is the tangent line of the sphere P, and the tangent point is P(Xₚ, Yₚ, Zₚ). A, F, and P can be taken to perform bundle adjustment and co-spherical intersection, and to establish the above-mentioned tangent co-spherical condition equation of the three points A, F, and P.

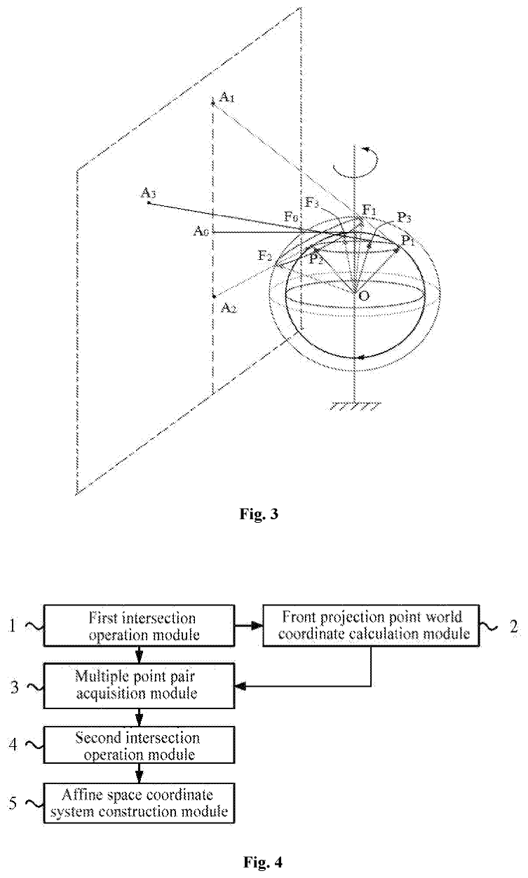

Referring to FIG. 3, it shows a three-dimensional diagram of calibration of structural parameters and an affine coordinate system of a two-degree-of-freedom hand-eye motion Referring to structure of the method for calibration of structural parameters and construction of an affine coordinate system of a vision measurement system according to the embodiment of the present application, taking the rotation center 0 of the pan-tilt as the coordinate origin of the affine coordinate system and considering that the corresponding vector \vec{(OP)ᵢ} of each Fi component in F(X_{f}, Y_{f}, Z_{f}) is acquired by rotation of vector \vec{OP}.

Therefore, the intersection point, namely the coordinate solution of the structural parameters and the world coordinate of rotation center of the pan-tilt of the target vision measurement system, can be acquired by solving the tangent co-spherical condition equation above according to the above solution process.

On the basis that the above calculation relations are known, the world coordinate O(X_{O}, Y_{O}, Z_{O}) of the intersection point of the rotation center in which systematic errors are corrected are acquired through stepwise iteration, and meanwhile the structural parameters d_{z0} and R are solved.

Wherein, the initial structural parameters d_{z0}⁰ and R⁰ of the target vision measurement system and the initial world coordinate O⁰(X_{O}⁰, Y_{O}⁰, Z_{O}⁰) of the rotation center of the pan-tilt are estimated according to the estimated values of the structural parameters and the estimated coordinate solution of the world coordinate of the rotation center of the pan-tilt of the target vision measurement system;

According to the error equation and the incremental vector of the coordinate of rotation center and the structural parameters, rotation center coordinate increments dX_{O}ⁱ, dY_{O}ⁱ and dZ_{O}ⁱ, and structural parameter increments d(d_{z0}ⁱ) and dRⁱ are acquired point by point;

based on the initial structure parameters d_{z0}⁰ and R⁰, the initial world coordinate O⁰(X_{O}⁰, Y_{O}⁰, Z_{O}⁰) of rotation center of the pan-tilt, the rotation center coordinate increments dX_{O}ⁱ, dY_{O}ⁱ and dZ_{O}ⁱ, and the structural parameter increments d(d_{z0}ⁱ) and dRⁱ, the approximate values at the previous iteration are added with the current rotation center coordinate increments and the structural parameter increments, so as to perform an iterative operation until both the rotation center coordinate increments and the structural parameter increments reach the set precision:

X_{O}ⁱ=X_{O}ⁱ⁻¹+dX_{O}ⁱ;

Y_{O}ⁱ=Y_{O}ⁱ⁻¹+dY_{O}ⁱ;

Z_{O}ⁱ=Z_{O}ⁱ⁻¹+dZ_{O}ⁱ;

d_{zo}ⁱ=d_{zo}ⁱ⁻¹+d(d_{zO}ⁱ);

Rⁱ=Rⁱ⁻¹+dRⁱ;

In the equations, Uⁱ represents the world coordinate of the rotation center of the pan-tilt or structural parameter at the current iteration, Uⁱ⁻¹ represents the world coordinate of the rotation center of the pan-tilt or structural parameter at the previous iteration, and dUⁱ represents the increment of the current rotation center coordinate or of the structural parameter, while U is taken as X_{O}, Y_{O}, Z_{O}, d_{z0} or R.

It can be understood that, specifically, when the iteration calibration of tangent co-spherical intersection is performed, the calculation process is performed as follows.

Before the tangent co-spherical intersection operation is performed, a world coordinate system of a two-dimensional calibration board needs to be established. When the front projected world coordinates of principal points of the image are acquired from the image plane, before the calculation of the projected world coordinates, systematic error correction is performed on the coordinates of the image points involved in the calculation thereof using the observation-value weight matrix W, and the world coordinates of the projected points of the front principal points on the calibration board are calculated.

The structural parameters and the world coordinate of the rotation center of the pan-tilt of the target vision measurement system are acquired after the initial values X_{O}⁰, Y_{O}⁰, Z⁰, d_{zo}⁰ and R⁰ are substituted, by successively substituting the coordinates of each first intersection point and the front projection points of the principal points of the image acquired according to the above embodiment into the tangent co-spherical intersection equation to get coordinate solution, in combination with the written error equation. The values of the three angular elements are substituted with the external elements acquired in the first adjustment collinear resection.

Wherein, according to the above embodiment, the approximate value of the intersection point coordinate F(X_{f}, Y_{f}, Z_{f}) corresponding to each of the different images is calculated point by point, and the different intersection point coordinates constitute the intersection point set.

According to the error equation and the incremental vector of the coordinate of rotation center and the structural parameters, rotation center coordinate increments dX_{O}ⁱ, dY_{O}ⁱ and dZ_{O}ⁱ and structural parameter increments d(d_{z0}ⁱ) and dRⁱ are acquired point by point.

Based on the initial structural parameters d_{z0}⁻⁰ and R⁰, and the initial world coordinate O⁰(XO⁰, Y_{O}⁰, Z_{O}⁰) of rotation center of the pan-tilt of the target vision measurement system, the rotation center coordinate increments DX_{O}ⁱ, DY_{O}ⁱ and dZ_{O}ⁱ and the structural parameter increments d(d_{z0}ⁱ) and dRⁱ calculated according to respective intersection point coordinates are sequentially superimposed to specifically acquire the above iterative equation.

Finally, the acquired rotation center coordinate increments dX_{O}ⁱ, dY_{O}ⁱ and dZ_{O}ⁱ and structural parameter increments d(d_{zo}ⁱ) and dRⁱ are compared with the predetermined tolerance, it is determined that whether the iteration reaches the set precision, and the iterative operation ends when the set precision is reached, and the rotation center coordinate O(X_{O}, Y_{O}, Z_{O}) and structural parameters d_{z0} and R are then output.

Wherein, in another embodiment, the step of S5 further includes: according to a given fixed focus f and the structural parameters d_{z0} and R, determining the initial focal point F₀; taking the point corresponding to the rotation center coordinate of the pan-tilt as the coordinate origin, rotating the pan-tilt successively to acquire the focal points Fᵢ of respective corresponding angle of views, and establishing an affine coordinate system of each corresponding angle of view.

It can be understood that, on the basis of the above embodiment, for a given fixed focus f, the initial point Fo coordinate (focal point), namely the initial focal point F₀(X_{f0}, Y_{f0}, Z_{fo}) of the first angle of view is determined according to the structural parameter _{z0}ⁱ and the rotation structural parameter R calibrated through steps S1 to S4. The affine coordinate system from the first angle of view is established.

Then, the pan-tilt is rotated with the rotation center O of the pan-tilt (or hand-eye system) as the coordinate origin, wherein the rotation matrix is:

$$R = [ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] .$$

The pan-tilt is rotated to the second angle of view. The coordinate of the focal point Fi at the second angle of view corresponding to the initial focus F₀(X_{f0}, Y_{f0}, Z_{fo}) at the first angle of view is:

$$[ \begin{matrix}{X}_{f 1} \\ {Y}_{f 1} \\ {Z}_{f 1}\end{matrix} ] = [ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] \cdot [ \begin{matrix}{X}_{f 0} \\ {Y}_{f 0} \\ {Z}_{f 0}\end{matrix} ] .$$

An affine coordinate system from the second angle of view is established.

Then, the rotation center O of the pan-tilt (or hand-eye system) is still taken as the coordinate origin, and the pan-tilt continues to be rotated successively to reach each required angle of view, and the focal point Fᵢ of each corresponding angle of view is acquired in turn, so as to establish affine coordinates at different angles of view, such that multi-view uncalibrated front intersection vision measurement is achieved.

That is, the pan-tilt is rotated by taking the rotation center O of the pan-tilt or the hand-eye system as the coordinate origin, to set the given fixed focus fᵢ, the structural parameter dz0ⁱ, and the rotating structural parameter R as the focal point coordinate of initial point F₀. The rotation matrix is as shown above.

The coordinate of the Fᵢ is acquired as shown above.

Then, with the rotation center O as the origin, rotation continues. With the rotation of the pan-tilt, affine coordinate systems with different angles of view are established sequentially, so as to realize the multi-view uncalibrated front intersection vision measurement.

The embodiment provides the following processing flow of the preferred technical solution so as to further illustrate the technical solution of the present application, rather than limit the scope of protection claimed by the present application.

Step 1, selecting one image from a plurality of calibrated images, performing bundle adjustment collinear resection on the image using the coordinates of the front point and the corresponding image point to acquire intersection point coordinates;

Step 2, calculating world coordinates of front projection points of front principal points corresponding to the acquired intersection point coordinates;

Step 3, traversing remaining frames of the plurality of calibrated images, performing Step 1 and Step 2 cyclically to acquire the pairs of intersection point coordinates and world coordinates of the front projection points of the principal image points corresponding to each image;

Step 4, based on the plurality of pairs of intersection point coordinates and world coordinates of the front projection points, performing tangent co-spherical second intersection, and acquiring the rotation center coordinate of the pan-tilt and structural parameters of the vision measurement system through iterative operation; and

Step 5, based on the structural parameters and the rotation center coordinate of the pan-tilt of the target vision measurement system, establishing an affine space coordinate system on the basis of the rotation center of the pan-tilt.

As another aspect of the embodiments of the present application, the embodiment provides a system for calibration of structural parameters and construction of an affine coordinate system of a vision measurement system. Referring to FIG. 4, it shows a structural diagram of the system for calibration of structural parameters and construction of an affine coordinate system of a vision measurement system according to the embodiment of the present application, comprising: a first intersection operation module 1, a front projection point world coordinate calculation module 2, a multi-group point pair acquisition module 3, a second intersection operation module 4 and an affine space coordinate system construction module 5. Wherein,

the first intersection operation module 1 is configured to acquire intersection point coordinates through bundle adjustment collinear resection; the front projection point world coordinate calculation module 2 is configured to acquire world coordinates of the front projection points of principal points corresponding to intersection point coordinates; the multi-group point pair acquisition module 3 is configured to control the first intersection operation module and the front projection point world coordinate calculation module to acquire a plurality of pairs of intersection point coordinates and world coordinates of front projection points according to a plurality of different calibrated images; the second intersection operation module 4 is configured to perform bundle adjustment tangent co-spherical second intersection based on the plurality of pairs of intersection point coordinates and world coordinates of the front projection points, and acquire the rotation center coordinate of the pan-tilt and structural parameters of the vision measurement system through iterative operations; and the affine space coordinate system construction module 5 is configured to establish an affine space coordinate system on the basis of the rotation center of the pan-tilt, according to the rotation center coordinate of the pan-tilt and the structural parameters.

It can be understood that, in order to solve the problem of low precision of the traditional parameter calibration method, in this embodiment, at least the following modules are respectively provided in the calibration system: the first intersection operation module 1, the front projection point world coordinate calculation module 2, the multi-group point pair acquisition module 3, the second intersection operation module 4 and the affine space coordinate system construction module 5. The communication connection between each function module can carry out data transmission with each other. It should be understood that the relevant functional modules in the system can be implemented by a hardware processor.

Wherein the first intersection operation module 1 writes a rear collinear condition equation through the bundle collinear resection, and calculates intersection point coordinates corresponding to each image with the adjustment algorithm. Namely, for each image, based on any image point on the image and the front point corresponding to any image point, the bundle collinear resection is performed, and the coordinate of the intersection point is acquired by iterative operation of the bundle adjustment corrected based on the observation weight matrix.

The front projection point world coordinate calculation module 2 acquires world coordinates of the corresponding front projection principal points based on the optical characteristics of the image space principal point and the projection of the image principal point coordinates along the principal optical axis in front.

Based on the processing of the above functional modules 1 and 2, when specifically considering the parameter calibration of the target vision measurement system, since the observation of the front projection principal points for only a few images will introduce great errors or even mistakes, the multi-group point pair acquisition module 3 needs to utilize the target vision measurement system to observe a plurality of pairs of corresponding points in the plurality of images separately, and calculate the more accurate focal point coordinates through the bundle adjustment collinear resection.

That is, the multi-group point pair acquisition module 3 is applied to traverse each of the plurality of images. For each image traversed, the multi-group point pair acquisition module 3 first writes the collinear conditions equation through the bundle adjustment collinear resection, and calculates the coordinates of corresponding resection points in each image with the adjustment algorithm. Then, the multi-group point pair acquisition module 3 acquires the intersection point coordinates and the world coordinates of the corresponding front projection principal points on the principal optical axis where the image principal point is located according to the optical characteristics of the front principal points. The optical characteristics of the principal points are the same as those in the above method embodiments, and reference may be made to the above method embodiments, which will not be repeated here.

After the multi-group point pair acquisition module 3 is used to perform the bundle adjustment collinear resection to acquire the resection point coordinates respectively corresponding to the multi-frame images and the corresponding world coordinates of the front principal points, the second intersection operation module 4 performs a bundle co-spherical second intersection using the resection point coordinates respectively corresponding to the multi-frame images and the world coordinates of the corresponding front principal point.

Specifically, according to the pairs of intersection point coordinates and world coordinates of the front principal points respectively corresponding to each image, and the space point P, the second intersection operation module 4 performs the bundle co-spherical intersection respectively, and writes a tangent co-spherical condition equation. Then, the second intersection operation module 4 performs iterative operation of adjustment according to a plurality of pairs of intersection point coordinates and world coordinates of the front principal points to acquire the structural parameters and the world coordinate of the rotation center of the pan-tilt of the target vision measurement system.

After the second intersection operation module 4 completes the calibration of the structural parameters and the rotation center of the pan-tilt of the target vision measurement system, the affine space coordinate system construction module 5 constructs affine coordinate systems under different angles of view of the target vision measurement system according to the calibrated structural parameters and the rotation center of the pan-tilt. For instance, taking the calibrated rotation center of the pan-tilt as the coordinate origin, it will sequentially reach each required angle of view by continuously rotating the pan-tilt, and in turn construct affine coordinate systems according to the structural parameters of the target vision measurement system under each angle of view.

The embodiment of present application provides a system for calibration of structural parameters and construction of an affine coordinate system of a vision measurement system. By arrangement of the relevant functional modules and on the basis of acquiring a plurality of intersection point coordinates and the corresponding world coordinates of the front principal points according to the bundle adjustment collinear intersection, a bundle adjustment tangent co-spherical second intersection is performed in the light of the intersection point coordinates and world coordinates of the front principal points, the structural parameters and the rotation center coordinate of the pan-tilt of the vision measurement system are solved, and the affine coordinate system of the vision measurement system on this basis is constructed, which can effectively improve the precision of parameter calibration of the motion structure of the target vision measurement system, thereby more precisely representing the affine relationship of the target vision measurement system, improving the vision measurement precision, and thus achieving the uncalibrated accurate measurement based on the vision measurement system's own structural parameters.

Optionally, the first intersection operation module 1 is specifically configured to establish a collinear condition equation for a group of corresponding projection points on two planes of the calibration board and the calibrated image, perform bundle adjustment calculation, and acquire an intersection point coordinate F(X_{f}, Y_{f}, Z_{f}):

the normal equation is:

(A₁^{T}WA₁)X₁=A₁^{T}WL₁;

then the solution of the normal equation is:

X₁=(A₁^{T}WA₁)⁻¹A₁^{T}WL₁;

in the equation, W is an observation-value weight matrix configured to introduce correction of system errors;

W=[c₁₁X+c₁₂), (c₂₁Y+c₂₂), (c₃₁Z+c₃₂)];

through iterative operation, acquiring the coordinate F(X_{f}, Y_{f}, Z_{f}) of the intersection point in which systematic errors are corrected;

the front projection point world coordinate calculation module 2 is specifically configured to: utilize the optical characteristics of the principal points to correct the calibrated image coordinates of the principal points using the observation-value weight matrix W configured to correct the optical distortion, based on the intersection point coordinates, in addition, by the calibrated image coordinates of the principal points corrected, solve the world coordinates of the principal points on the calibration board, and acquire the world coordinates of the front projection points.

Wherein, in one embodiment, the second intersection operation module 4 is specifically configured to:

taking each pair of corresponding points in the F(X_{f}, Y_{f}, Z_{f}) point set of the intersection point coordinates acquired in one intersection and the world coordinate A(X, Y, Z) point set of the front projection points as a group of corresponding projection points, which respectively correspond to a corresponding point in the space point set P in pairs, and establishing a tangent co-spherical condition equation; F(X_{f}, Y_{f}, Z_{f}) and P are each a co-spherical point set, a straight line AFP is the tangent line of a sphere P with P being the tangent point; perform co-spherical second intersection with A, F and P, and acquire a world coordinates O(X_{O}, Y_{O}, Z_{O}) of the intersection point of the rotation center through iterative operation, meanwhile solving structure parameters d_{zo} and R;

a corresponding vector \vec{OPᵢ} of each Fᵢ in F(X_{f}, Y_{f}, Z_{f}) is acquired by the rotation of vector \vec{OP}, and a rotation matrix from \vec{OP} to \vec{OPᵢ}is

$$[ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] ;$$

the tangent equation of the three points A, F and P is:

$$\frac{X - {X}_{p}}{{X}_{f} - {X}_{p}} = \frac{Y - {Y}_{p}}{{Y}_{f} - {Y}_{p}} = \frac{Z - {Z}_{p}}{{Z}_{f} - {Z}_{p}} = \frac{1}{λ} ;$$

the solution is:

$${X}_{f} = \frac{( X - {X}_{O} - {a}_{2} \cdot R )}{Z - {Z}_{O} - {c}_{2} \cdot R} \cdot {d}_{z 0} \cdot {c}_{3} + {X}_{O} + {a}_{2} \cdot R ;$$

$${Y}_{f} = \frac{( Y - {Y}_{O} - {a}_{2} \cdot R )}{Z - {Z}_{O} - {c}_{2} \cdot R} \cdot {d}_{z 0} \cdot {c}_{3} + {Y}_{O} + {a}_{2} \cdot R ;$$

in which X_{f}, Y_{f}, Z_{f} are the coordinate components of the intersection point of the bundle adjustment collinear resection, (X_{O}, Y_{O}, Z_{O}) is the intersection point coordinate of the bundle adjustment co-spherical intersection, that is, the world coordinate of the rotation center of the pan-tilt, d_{zo} and R are the structural parameters of the target vision measurement system;

the error equation is:

V₂₌A₂X₂−L₂;

wherein:

$${V}_{2} = {[ {v}_{x} , {v}_{y} ]}^{T} ;$$

$${v}_{x} = {a}_{11} {dX}_{O} + {a}_{12} {dY}_{O} + {a}_{13} {dZ}_{O} + {a}_{14} d ( {d}_{z 0} ) + {a}_{15} dR - {l}_{x} ;$$

$${v}_{y} = {a}_{21} {dX}_{O} + {a}_{22} {dY}_{O} + {a}_{23} {dZ}_{O} + {a}_{24} d ( {d}_{z 0} ) + {a}_{25} dR - {l}_{y} ;$$

$${L}_{2} = {[ {l}_{x} , {l}_{y} ]}^{T} ;$$

$${l}_{x} = {X}_{f} - ( {X}_{f} ) = {X}_{f} + \frac{( X - {X}_{O} - {a}_{2} \cdot R )}{Z - {Z}_{O} - {c}_{2} \cdot R} \cdot {d}_{z 0} \cdot {c}_{3} + {X}_{O} + {a}_{2} \cdot R \\ {l}_{y} = {Y}_{f} - ( {Y}_{f} ) = {Y}_{f} + \frac{( Y - {Y}_{O} - {a}_{2} \cdot R )}{Z - {Z}_{O} - {c}_{2} \cdot R} \cdot {d}_{z 0} \cdot {c}_{3} + {Y}_{O} + {a}_{2} \cdot R \\ {A}_{2} = [ \begin{matrix}{a}_{11} & {a}_{12} & {a}_{13} & {a}_{14} & {a}_{15} \\ {a}_{21} & {a}_{22} & {a}_{23} & {a}_{24} & {a}_{25}\end{matrix} ] ;$$

$${X}_{2} = {[ \begin{matrix}d {X}_{O} & {dY}_{O} & {dZ}_{O} & d ( {d}_{z 0} ) & dR\end{matrix} ]}^{T} ;$$

the normal equation is:

(A₂^{T}WA₂)X₂=A₂^{T}WL₂;

the solution to the normal equation is:

X₂=(A₂^{T}WA₂)⁻¹A₂^{T}WL₂;

in which W is an observation-value weight matrix for introducing systematic errors correction;

W=[(c₁₁X+c₁₂), (c₂₁Y+c₂₂), (c₃₁Z+c₃₂)];

in the equation, A₂ is a second observation matrix, W is an observation-value weight matrix that introduces error correction components, W=[(c₁₁X+c₁₂), (c₂₁Y+c₂₂), (c₃₁Z+c₃₂)], wherein X, Y, Z represent the parametric variables of the front principal point of the tangent condition equation in the calculation of bundle tangent co-spherical intersection, c₁₁, c₁₂, c₂₁, c₂₂, c₃₁ and c₃₂ represent the compensation coefficients, X₂ is an increment vector of the rotation center coordinate and the structural parameters, and L₂ is a linearized transformation vector of the tangent co-spherical condition equation;

the items in are:

$${A}_{2} = [ \begin{matrix}{a}_{11} & {a}_{12} & {a}_{13} & {a}_{14} & {a}_{15} \\ {a}_{21} & {a}_{22} & {a}_{23} & {a}_{24} & {a}_{25}\end{matrix} ]$$

$${a}_{11} = - \frac{{\partial }_{{X}_{f}}}{{\partial }_{{X}_{O}}} = - \frac{{d}_{z 0} \cdot {c}_{3}}{Z - {Z}_{O} - {c}_{2} \cdot R} + 1 ;$$

$${a}_{12} = - \frac{{\partial }_{{X}_{f}}}{{\partial }_{{Y}_{O}}} = 0 ;$$

$${a}_{13} = - \frac{{\partial }_{{X}_{f}}}{{\partial }_{{Z}_{O}}} = - ( X - {X}_{O} - {a}_{2} \cdot R ) \cdot ( {d}_{z 0} \cdot {c}_{3} ) \cdot \frac{1}{{( Z - {Z}_{O} - {c}_{2} \cdot R )}^{2}} ;$$

$${a}_{14} = \frac{{\partial }_{{X}_{f}}}{{\partial }_{R}} = \frac{\begin{matrix}{a}_{2} \cdot {d}_{z 0} \cdot {c}_{3} \cdot ( Z - {Z}_{O} - {c}_{2} \cdot R ) - \\ {c}_{2} \cdot {d}_{z 0} \cdot {c}_{3} \cdot ( X - {X}_{O} - {a}_{2} \cdot R )\end{matrix}}{{( Z - {Z}_{O} - {c}_{2} \cdot R )}^{2}} + a 2 ;$$

$${a}_{15} = - \frac{{\partial }_{{X}_{f}}}{{\partial }_{{d}_{z 0}}} = - {c}_{3} \cdot \frac{X - {X}_{O} - {a}_{2} \cdot R}{Z - {Z}_{O} - {c}_{2} \cdot R} ;$$

$${a}_{21} = - \frac{{\partial }_{{Y}_{f}}}{{\partial }_{{X}_{o}}} = 0 ;$$

$${a}_{22} = - \frac{{\partial }_{{Y}_{f}}}{{\partial }_{{Y}_{o}}} = - \frac{{d}_{z 0} \cdot {c}_{3}}{Z - {Z}_{o} - {c}_{2} \cdot R} + 1 ;$$

$${a}_{23} = - \frac{{\partial }_{{Y}_{f}}}{{\partial }_{{Z}_{O}}} = - ( Y - {Y}_{O} - {a}_{2} \cdot R ) \cdot ( {d}_{z 0} \cdot {c}_{3} ) \cdot \frac{1}{{( Z - {Z}_{O} - {c}_{2} \cdot R )}^{2}} ;$$

$${a}_{24} = - \frac{{\partial }_{{Y}_{f}}}{{\partial }_{R}} = \frac{\begin{matrix}{b}_{2} \cdot {d}_{z 0} \cdot {c}_{3} \cdot ( Z - {Z}_{O} - {c}_{2} \cdot R ) - \\ {c}_{2} \cdot {d}_{z 0} \cdot {c}_{3} \cdot ( X - {X}_{O} - {a}_{2} \cdot R )\end{matrix}}{{( Z - {Z}_{O} - {c}_{2} \cdot R )}^{2}} + b 2 ;$$

$${a}_{25} = - \frac{{\partial }_{{Y}_{f}}}{{\partial }_{{d}_{z 0}}} = - {c}_{3} \cdot \frac{Y - {Y}_{O} - {a}_{2} \cdot R}{Z - {Z}_{O} - {c}_{2} \cdot R} ;$$

through iterative operation, acquiring the world coordinate O(X_{O}, Y_{O}, Z_{O}) of the intersection point of the rotation center in which systematic errors are corrected, and the structural parameters d_{z0} and R;

wherein, the calculation process of performing the co-spherical second intersection and iterative operation is:

establishing a world coordinate system of a two-dimensional calibration board, acquiring image coordinates of the principal points from an image plane, and performing systematic error correction on the image point coordinates using the matrix W;

calculating the world coordinates of the projected points of the principal points on the calibration board using the image coordinates of the principal points;

roughly estimating the initial values X_{O}⁰, Y_{O}⁰, Z_{O}⁰, d_{z0}⁰ and R⁰ based on the equipment conditions of the actual calibration experiment;

substituting the values of three angular elements with external orientation elements acquired from the first collinear intersection;

calculating the approximate values of each point in the F(X_{f}, Y_{f}, Z_{f}) point set point by point;

calculating corrected numerical values dX_{O}, dY_{O}, dZ_{O} of spherical center coordinate and corrected numerical values d(d_{z0}) and dR of structural parameters point by point;

calculating the values of the current iteration by means of the approximate values at the previous iteration plus the corrected numerical values:

X_{O}ⁱ=X_{O}ⁱ⁻¹+dX_{O}ⁱ; Y_{O}ⁱY_{O}ⁱ⁻¹+dY_{O}ⁱ; Z_{O}ⁱ=Z_{O}ⁱ⁻¹+dZ_{O}ⁱ; d_{z0}ⁱ=d_{z0}ⁱ⁻¹+d(d_{z0}ⁱ); Rⁱ=Rⁱ⁻¹+dRⁱ;

comparing the corrected numerical values dX_{O}, dY_{O}, dZ_{O} of the calculated spherical center coordinate and the corrected numerical values d(d_{z0}) and dR of the calculated structural parameters with the predetermined tolerance, allowing the iteration to end if the accuracy is reached, and then outputting the spherical center coordinate O(X_{O}, Y_{O}, Z_{O}) and the structural parameters d_{z0} and R.

Wherein, in another embodiment, the affine space coordinate system construction module 5 is specifically configured to:

by taking the rotation center O of the pan-tilt or hand-eye system as the coordinate origin, to set the given fixed focus fᵢ and the structural parameters d_{z0}ⁱ and rotating structural parameters R as the focal point coordinate of initial point F₀, rotate the pan-tilt, with the rotation matrix being:

$$[ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] ;$$

acquiring the coordinate of F₁ as:

$$[ \begin{matrix}{X}_{f 1} \\ {Y}_{f 1} \\ {Z}_{f 1}\end{matrix} ] = [ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] \cdot [ \begin{matrix}{X}_{f 0} \\ {Y}_{f 0} \\ {Z}_{f 0}\end{matrix} ] ;$$

still with the rotation center O as the origin, rotation continues. With the rotation of the pan-tilt, affine coordinate systems of different angles of view are established in sequence, so as to realize the vision measurement of multi-angle uncalibrated front intersection.

It should be understood that in the various embodiments of system for calibration of structural parameters and construction of an affine coordinate system of vision measurement system of the present application, the specific processing process of each functional module corresponds to the above method embodiments, and reference may be made to the above method embodiments, which will not be repeated here.

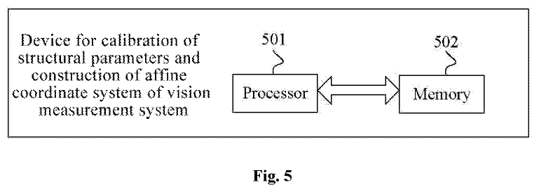

As still another aspect of the embodiments of the present application, the embodiment provides a device for calibration of structural parameters and construction of an affine coordinate system of a vision measurement system. Referring to FIG. 5, it shows a structural block diagram of the device for calibration of structural parameters and construction of an affine coordinate system of a vision measurement system according to the embodiment of the present application, comprising: at least one processor 501, and at least one memory 502 in communication with the processor 501. Wherein, the memory 502 stores computer programs that can run on the processor 501, and when the processor 501 executes the computer program, the above-mentioned method for calibration of structural parameters and construction of an affine coordinate system of a vision measurement system is implemented.

It can be understood that the device for calibration of structure parameters and construction of an affine coordinate system of a vision measurement system at least includes one processor 501 and one memory 502, and a communication connection is formed between the processor 501 and the memory 502, which can perform mutual transmission of information and instruction, such as the processor 501 reading the program instructions for the method for calibration of structural parameters and construction of an affine coordinate system of the vision measurement system from the memory 502, and the like.

When the device for calibration of structural parameters and construction of an affine coordinate system of a vision measurement system is in operation, the processor 501 calls the program instructions in the memory 502 to execute the methods provided by the above method embodiments, for example, including: based on the intersection point coordinates corresponding to each calibrated image and the world coordinates of the front principal points, acquiring the structural parameters and the world coordinate of the rotation center of the pan-tilt of the target vision measurement system through iterative operation of the bundle adjustment co-spherical intersection; and, for each image, based on any image point on the image and the front principal point corresponding to the any image point, performing a bundle collinear resection, and acquiring the intersection point coordinates, etc. by iterative operation of the bundle adjustment corrected based on the observation-value weight matrix.

In another embodiment of the present application, a non-transitory computer-readable storage medium is provided. The non-transitory computer-readable storage medium stores computer instructions which cause the computer to execute the method for calibration of structural parameters and construction of an affine coordinate system of the vision measurement system mentioned above.

It can be understood that, the logic instructions in the above memory 502 may be implemented in the form of software functional units and sold or used as an independent product, and may be stored in a computer-readable storage medium. Alternatively, all or part of the steps to implement the above method embodiments can be completed by program instructions related hardware. The aforementioned program can be stored in a computer readable storage medium. When the program is run, the steps including the aforementioned method embodiments are executed; and the aforementioned storage medium includes various media that can store program codes, such as U disk, removable hard disk, ROM, RAM, magnetic disk, compact disk, and the like.

The embodiments of the device for calibration of structural parameters and construction of an affine coordinate system of a vision measurement system described above are only schematic, wherein the units described as separate components may or may not be physically separated, and they may be located in one place or, may be distributed to different network units. Some or all of the modules may be selected according to actual needs to achieve the purpose of the solution of this embodiment. It can be understood and implemented by a person of ordinary skill in the art without paying creative labor.

Through the description of the above embodiments, it can be clearly understood by those skilled in the art that each embodiment can be implemented by means of software plus a necessary general hardware platform, and of course, it can also be implemented by hardware. Based on this understanding, the essence or the part that contributes to the existing technology of the technical solutions mentioned above can be embodied in the form of software products, and the computer software products can be stored in computer readable storage media, such as U disk, removable hard disk, ROM, RAM, magnetic disc, compact disc, and the like. The software includes several instructions to enable a computer device (may be a personal computer, server, or network device, etc.) to execute the methods of various embodiments or some parts of the embodiments.

The embodiment of present application provides a device for calibration of structural parameters and construction of an affine coordinate system of a vision measurement system and a non-transitory computer-readable storage medium. On the basis of acquiring a plurality of intersection point coordinates and the corresponding world coordinates of the front principal points according to the bundle adjustment collinear intersection, a bundle adjustment tangent co-spherical second intersection is performed in the light of the intersection point coordinates and world coordinates of the front principal point, the structural parameters and the rotation center coordinate of the pan-tilt of the vision measurement system are solved, and the affine coordinate system of the vision measurement system is constructed on this basis, which can effectively improve the precision of parameter calibration of the motion structure of the target vision measurement system, thereby more precisely representing the affine relationship of the target vision measurement system and improving the vision measurement precision.

In addition, it should be understood by those skilled in the art that in the application documents of the present invention, the terms “comprise”, “include” or any other variant thereof are intended to cover non-exclusive inclusion, so that a process, method, article or equipment that includes a series of elements includes not only those elements, but also other elements that are not explicitly listed, or includes elements inherent to such a process, method, article or equipment. Without more restrictions, the elements defined by the phrase “including a . . . ” do not exclude the existence of other identical elements in the process, method, article or equipment that includes the elements.

In the description of the present invention, a large number of specific details are explained. It should be understood, however, the embodiments of the present invention can be practiced without these specific details. In some instances, common methods, structures and techniques have not been shown in detail so as not to obscure the understanding of the description. Similarly, it should be understood, in order to streamline the disclosure of the present invention and to facilitate the understanding of one or more of the various inventive aspects, in the above-mentioned description of exemplary embodiments of the present invention, various features of the present invention are sometimes grouped together into a single embodiment, figure or description thereof

However, the disclosed method herein should not be interpreted as reflecting an intent that the present invention sought to be protected possess more features than those expressly documented in each claim. To be more precise, as reflected in the claims, the inventive aspects are less than all features of the single embodiment disclosed above. Therefore, the claims that follow the specific embodiment are hereby expressly incorporated into the specific embodiment, where each claim itself serves as a separate embodiment of the present invention.

Finally, it should be noted that the embodiments above are only for illustrating the technical solutions of the present invention, rather than limiting them; although the present invention has been described in detail with reference to the foregoing embodiments, those skilled in the art should understand that the technical solutions documented in the preceding embodiments can still be modified, or parts of the technical features thereof can be equivalently substituted; and such modifications or substitutions do not make the essence of the corresponding technical solutions deviate from the spirit and scope of the technical solutions of the embodiments of the present invention.

1. A method for calibrating structural parameters and constructing an affine coordinate system of a vision measurement system, comprising:
S1, acquiring intersection point coordinates through a bundle adjustment collinear resection;
S2, acquiring world coordinates of front projection points of principal points corresponding to the intersection point coordinates;
S3, performing steps S1 and S2 cyclically by utilizing a plurality of different calibrated images to acquire a plurality of pairs of intersection point coordinates and world coordinates of the front projection points;
S4, based on the plurality of pairs of intersection point coordinates and world coordinates of the front projection points, performing bundle adjustment tangent co-spherical second intersection, and acquiring rotation center coordinate of a pan-tilt and structural parameters of the vision measurement system through iterative operation; and
S5, based on the rotation center coordinate of the pan-tilt and the structural parameters, establishing an affine space coordinate system on the basis of the rotation center of the pan-tilt.

2. The method according to claim 1, wherein the step of S1 further comprises:
establishing a collinear condition equation for a group of corresponding projection points on two planes of a calibration board and a calibrated image, performing bundle adjustment calculation, and acquiring an intersection point coordinate F (X_{f}, Y_{f}, Z_{f});
the normal equation is:
(A₁^{T}WA₁)X₁=A₁^{T}WL₁;
then the solution of the normal equation is:
X₁=(A₁^{T}WA₁)⁻¹A₁^{T}WL₁;
in the equation, W is an observation-value weight matrix configured to introduce correction of systematic errors;
W=[(c₁₁X+c₁₂), (c₂₁Y+c₂₂), (c₂₁Z+c₃₂)];
through iterative operation, acquiring the intersection point coordinate F(Xf, Yf, Zr) in which systematic errors are corrected.

3. The method according to claim 2, wherein the step of S2 further comprises:
based on the intersection point coordinates, correcting coordinates of a calibrated image of the principle points by means of the observation-value weight matrix Wfor correction of optical distortion, and utilizing the optical characteristics of the principle points to solve world coordinates of the principle points on the calibration board according to the corrected coordinates of the calibrated image of the principle points, and acquiring the world coordinates of the front projection points.

4. The method according to claim 2, wherein the step of S3 further comprises:
traversing all the calibrated images, performing steps S1 and S2 cyclically, acquiring an F(X_{f}, Y_{f}, Z_{f}) point set of the intersection point coordinates, and a corresponding world coordinate A(X, Y, Z) point set of the front projection points in which systematic errors are corrected.

5. The method according to claim 4, wherein the step of S4 further comprises:
taking each pair of corresponding points in the F(X_{f}, Y_{f}, Z_{f}) point set of the intersection point coordinates acquired in one intersection and the world coordinate A(X, Y, Z) point set of the front projection points as a group of corresponding projection points, which respectively correspond to a corresponding point in a space point set P in pairs, establishing a tangent co-spherical condition equation; F(X_{f}, Y_{f}, Z_{f}) and P are each a co-spherical point set, straight line AFP is a tangent line of a sphere P with P being the tangent point; performing co-spherical second intersection with A, F and P, and acquiring a world coordinate O(X_{O}, Y_{O}, Z_{O}) of the intersection point of the rotation center through iterative operation, meanwhile solving structural parameters d_{zo} and R; acquiring a corresponding vector \vec{(OP)ᵢ} of each F₁ in F(X_{f}, Y_{f}, Z_{f}) by the rotation of vector \vec{OP}, and a rotation matrix from \vec{OP} to \vec{(OP)}, being
$$[ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] ;$$
the tangent equation of the three points A, F and P being:
$$\frac{X - {X}_{p}}{{X}_{f} - {X}_{p}} = \frac{Y - {Y}_{p}}{{Y}_{f} - {Y}_{p}} = \frac{Z - {Z}_{p}}{{Z}_{f} - {Z}_{p}} = \frac{1}{λ} ;$$
the solution being:
$${X}_{f} = \frac{( X - {X}_{O} - {a}_{2} \cdot R )}{Z - {Z}_{O} - {c}_{2} \cdot R} \cdot {d}_{z 0} \cdot {c}_{3} + {X}_{O} + {α}_{2} \cdot R ;$$
$${Y}_{f} = \frac{( Y - {Y}_{O} - {a}_{2} \cdot R )}{Z - {Z}_{O} - {c}_{2} \cdot R} \cdot {d}_{z 0} \cdot {c}_{3} + {Y}_{O} + {a}_{2} \cdot R ;$$
in which X_{f}, Y_{f}, Z_{f} are components of the intersection point coordinate of the bundle adjustment collinear resection, (X_{O}, Y_{O}, Z_{O}) is the intersection point coordinate of the bundle adjustment co-spherical intersection, that is, world coordinate of the rotation center of the pan-tilt, d_{z0} and R are the structural parameters of the target vision measurement system;
the error equation is:
$${V}_{2} = {A}_{2} {X}_{2} - {L}_{2} ;$$
$$Wherein : \\ {V}_{2} = {[ {v}_{x} , {v}_{y} ]}^{T} ;$$
$${v}_{x} = {a}_{11} {dX}_{O} + {a}_{12} {dY}_{O} + {a}_{13} {dZ}_{O} + {a}_{14} d ( {d}_{z 0} ) + {a}_{15} dR - {l}_{x} ;$$
$${v}_{y} = {a}_{21} {dX}_{O} + {a}_{22} {dY}_{O} + {a}_{23} {dZ}_{O} + {a}_{24} d ( {d}_{z 0} ) + {a}_{25} dR - {l}_{y} ;$$
$${L}_{2} = {[ {l}_{x} , {l}_{y} ]}^{T} ;$$
$${l}_{x} = {X}_{f} - ( {X}_{f} ) = {X}_{f} + \frac{( X - {X}_{O} - {a}_{2} \cdot R )}{Z - {Z}_{O} - {c}_{2} \cdot R} \cdot {d}_{z 0} \cdot {c}_{3} + {X}_{O} + {a}_{2} \cdot R \\ {l}_{y} = {Y}_{f} - ( {Y}_{f} ) = {Y}_{f} + \frac{( Y - {Y}_{O} - {a}_{2} \cdot R )}{Z - {Z}_{O} - {c}_{2} \cdot R} \cdot {d}_{z 0} \cdot {c}_{3} + {Y}_{O} + {a}_{2} \cdot R \\ {A}_{2} = [ \begin{matrix}{a}_{11} & {a}_{12} & {a}_{13} & {a}_{14} & {a}_{15} \\ {a}_{21} & {a}_{22} & {a}_{23} & {a}_{24} & {a}_{25}\end{matrix} ] ;$$
$${X}_{2} = {[ \begin{matrix}d {X}_{O} & {dY}_{O} & {dZ}_{O} & d ( {d}_{z 0} ) & dR\end{matrix} ]}^{T} ;$$
the normal equation is:
(A₂^{T}WA₂)X₂=A₂^{T}WL₂;
the solution to the normal equation is:
X₂₌₍A₂^{T}WA₂), A₂^{T}WL₂;
in which W is an observation-value weight matrix that introduces systematic errors correction;
W=[(c₁₁X+c₁₂), c₂₁Y+c₂₂); (c₃₁Z+c₃₂];
in the equation, A₂ is a second observation matrix, W is the observation-value weight matrix that introduces error correction components,
W=[(c₁₁X+c₁₂), (c₂₁Y+c₂₂), (c₃₁Z+c₃₂)], wherein X, Y, Z represent the parametric variables of the front principal point of the tangent condition equation in the calculation of bundle tangent co-spherical intersection, c₁₁, c₁₂, c₃₁, c₂₂, c₃₁, c₃₂ represent compensation coefficients, X₂ is an incremental vector of the rotation center coordinate and the structural parameters, and L₂ is a linearized transformation vector of the tangent co-spherical condition equation;
the items in
$${A}_{2} = [ \begin{matrix}{a}_{11} & {a}_{12} & {a}_{13} & {a}_{14} & {a}_{15} \\ {a}_{21} & {a}_{22} & {a}_{23} & {a}_{24} & {a}_{25}\end{matrix} ]$$
are:
$${a}_{11} = - \frac{{\partial }_{{X}_{f}}}{{\partial }_{{X}_{O}}} = - \frac{{d}_{z 0} \cdot {c}_{3}}{Z - {Z}_{O} - {c}_{2} \cdot R} + 1 ;$$
$${a}_{12} = - \frac{{\partial }_{{X}_{f}}}{{\partial }_{{Y}_{O}}} = 0 ;$$
$${a}_{13} = - \frac{{\partial }_{{X}_{f}}}{{\partial }_{{Z}_{O}}} = - ( X - {X}_{O} - {a}_{2} \cdot R ) \cdot ( {d}_{z 0} \cdot {c}_{3} ) \cdot \frac{1}{{( Z - {Z}_{O} - {c}_{2} \cdot R )}^{2}} ;$$
$${a}_{14} = \frac{{\partial }_{{X}_{f}}}{{\partial }_{R}} = \frac{\begin{matrix}{a}_{2} \cdot {d}_{z 0} \cdot {c}_{3} \cdot ( Z - {Z}_{O} - {c}_{2} \cdot R ) - \\ {c}_{2} \cdot {d}_{z 0} \cdot {c}_{3} \cdot ( X - {X}_{O} - {a}_{2} \cdot R )\end{matrix}}{{( Z - {Z}_{O} - {c}_{2} \cdot R )}^{2}} + a 2 ;$$
$${a}_{15} = - \frac{{\partial }_{{X}_{f}}}{{\partial }_{{d}_{z 0}}} = - {c}_{3} \cdot \frac{X - {X}_{O} - {a}_{2} \cdot R}{Z - {Z}_{O} - {c}_{2} \cdot R} ;$$
$${a}_{21} = - \frac{{\partial }_{{Y}_{f}}}{{\partial }_{{X}_{o}}} = 0 ;$$
$${a}_{22} = - \frac{{\partial }_{{Y}_{f}}}{{\partial }_{{Y}_{o}}} = - \frac{{d}_{z 0} \cdot {c}_{3}}{Z - {Z}_{o} - {c}_{2} \cdot R} + 1 ;$$
$${a}_{23} = - \frac{{\partial }_{{Y}_{f}}}{{\partial }_{{Z}_{O}}} = - ( Y - {Y}_{O} - {a}_{2} \cdot R ) \cdot ( {d}_{z 0} \cdot {c}_{3} ) \cdot \frac{1}{{( Z - {Z}_{O} - {c}_{2} \cdot R )}^{2}} ;$$
$${a}_{24} = - \frac{{\partial }_{{Y}_{f}}}{{\partial }_{R}} = \frac{\begin{matrix}{b}_{2} \cdot {d}_{z 0} \cdot {c}_{3} \cdot ( Z - {Z}_{O} - {c}_{2} \cdot R ) - \\ {c}_{2} \cdot {d}_{z 0} \cdot {c}_{3} \cdot ( X - {X}_{O} - {a}_{2} \cdot R )\end{matrix}}{{( Z - {Z}_{O} - {c}_{2} \cdot R )}^{2}} + b 2 ;$$
$${a}_{25} = - \frac{{\partial }_{{Y}_{f}}}{{\partial }_{{d}_{z 0}}} = - {c}_{3} \cdot \frac{Y - {Y}_{O} - {a}_{2} \cdot R}{Z - {Z}_{O} - {c}_{2} \cdot R} ;$$
through iterative operation, acquiring the world coordinate O(X_{O}, Y_{O}, Z_{O}) of the intersection point of the rotation center in which systematic errors are corrected, and the structural parameters d_{z0} and R;
wherein the calculation process of performing the co-spherical second intersection and iterative operation includes:
establishing a world coordinate system of a two-dimensional calibration board, acquiring image coordinates of the principal points from an image plane, and performing systematic error correction on the image point coordinates using the matrix W;
calculating the world coordinates of the projected points of the principal points on the calibration board using the image coordinates of the principal points;
roughly estimating the initial values X_{O}⁰, Y_{O}⁰, Z_{O}⁰, d_{z0}⁰ and R⁰ based on equipment conditions of an actual calibration experiment;
substituting the values of three angular elements with external orientation elements acquired from the first collinear intersection;
calculating the approximate value of each point in the F(X_{f}, Y_{f}, Z_{f}) point set point by point;
calculating the corrected numerical values dX_{O}, dY_{O}, dZ_{O} of spherical center coordinate and the corrected numerical values d(d_{z0})and dR of the structural parameters point by point;
calculating the values of the current iteration by adding approximate values at the previous iteration to the corrected numerical values:
X_{O}ⁱ=X_{O}ⁱ⁻¹+dX_{O}ⁱ; Y_{O}ⁱY_{O}ⁱ⁻¹+dY_{O}ⁱ; Z_{O}ⁱ=Z_{O}ⁱ⁻¹+dZ_{O}ⁱ; d_{z0}ⁱ=d_{z0}ⁱ⁻¹+d(d_{z0}ⁱ); Rⁱ=Rⁱ⁻¹+dRⁱ;
comparing the corrected numerical values dX_{O}, dY_{O}, dZ_{O} of the calculated spherical center coordinates and the corrected numerical values d(d_{z0}) and dR of the calculated structural parameters with a predetermined tolerance, allowing the iteration to end if the precision is reached, and then outputting the spherical center coordinate O(X_{O}, Y_{O}, Z_{O}) and the structural parameters d_{z0} and R.

6. The method according to claim 4, wherein the step of S5 further comprises:
taking the rotation center O of the pan-tilt or hand-eye system as the coordinate origin, to set the given fixed focus fᵢ and the structural parameters d_{z0}ⁱ and rotating structural parameters R as the focal point coordinate of initial point F₀, rotating the pan-tilt, with the rotation matrix being:
$$[ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] ;$$
acquiring the coordinate of F₁ as:
$$[ \begin{matrix}{X}_{f 1} \\ {Y}_{f 1} \\ {Z}_{f 1}\end{matrix} ] = [ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] \cdot [ \begin{matrix}{X}_{f 0} \\ {Y}_{f 0} \\ {Z}_{f 0}\end{matrix} ] ;$$
still taking the rotation center O as the origin, continuing to rotate, with the rotation of the pan-tilt, establishing the affine coordinate systems of different angles of view in sequence, so as to realize the vision measurement of multi-angle uncalibrated front intersection.

7. A system for calibration of structural parameters and construction of an affine coordinate system of a vision measurement system, comprising:
a first intersection operation module configured to acquire intersection point coordinates through a bundle adjustment collinear resection;
a front projection point world coordinate calculation module configured to acquire world coordinates of the front projection points of principal points corresponding to intersection point coordinates;
a multi-group point pair acquisition module configured to control the first intersection operation module and the front projection point world coordinate calculation module to acquire a plurality of pairs of intersection point coordinates and world coordinates of the front projection points according to a plurality of different calibrated images;
a second intersection operation module configured to perform a bundle adjustment tangent co-spherical second intersection based on the plurality of pairs of the intersection point coordinates and world coordinates of the front projection points, and acquire rotation center coordinate of the pan-tilt and structural parameters of the vision measurement system through iterative operation; and
an affine space coordinate system construction module configured to establish an affine space coordinate system on the basis of the rotation center of the pan-tilt, based on the rotation center coordinate of the pan-tilt and the structural parameters.

8. The system according to claim 7, wherein the first intersection operation module is specifically configured to:
establish a collinear condition equation for a group of corresponding projection points on two planes of a calibration board and a calibrated image, perform bundle adjustment calculation, and acquire an intersection point coordinate F(X_{f}, Y_{f}, Z_{f}):
the normal equation is:
(A₁^{T}WA₁)=A₁^{T}WL₁;
then the solution of the normal equation is:
X₁=(A₁^{T}WA₁)⁻¹A₁^{T}WL₁;
in the equation, W is an observation-value weight matrix configured to introduce correction of systematic errors;
W=[(c₁₁X+c₁₂), (c₂₁ Y+c₂₂), (c₃₁Z+c₃₂)];
through iterative operation, acquire the intersection point coordinate F(X_{f}, Y_{f}, Z_{f}) in which systematic errors are corrected;
the front projection point world coordinate calculation module is specifically configured to:
based on the intersection point coordinates, correct the coordinates of a calibrated image of the principle points by means of the observation-value weight matrix Wfor correction of optical distortion, and utilize the optical characteristics of the principle points to solve world coordinates of the principle points on the calibration board according to the corrected coordinates of the calibrated image of the principle points, and acquire the world coordinates of the front projection points.

9. The system according to claim 7, wherein the second intersection operation module is specifically configured to:
by taking each pair of corresponding points in an F(X_{f}, Y_{f}, Z_{f}) point set of the intersection point coordinates acquired in one intersection and a world coordinate A (X, Y, Z) point set of the front projection points as a group of corresponding projection points, which respectively correspond to a corresponding point in a space point set P in pairs, establish a tangent co-spherical condition equation; F(X_{f}, Y_{f}, Z_{f}) and P are each a co-spherical points set, straight line AFP is a tangent line of a sphere P with P being the tangent point; perform co-spherical second intersection with A, F and P, and acquire a world coordinate O(X_{O}, Y_{O}, Z_{O}) of the intersection point of the rotation center through iterative operation, meanwhile solving structural parameters d_{zo} and R;
acquire a corresponding vector \vec{OPᵢ} of each Fᵢ in F(X_{f}, Y_{f}, Z_{f}) by the rotation of
$$[ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] ;$$
vector \vec{OP}, and a rotation matrix from \vec{OP} to \vec{(OP)ᵢ}, is the tangent equation of the three points A, F and P is:
$$\frac{X - {X}_{p}}{{X}_{f} - {X}_{p}} = \frac{Y - {Y}_{p}}{{Y}_{f} - {Y}_{p}} = \frac{Z - {Z}_{p}}{{Z}_{f} - {Z}_{p}} = \frac{1}{λ} ;$$
the solution is:
$${X}_{f} = \frac{( X - {X}_{O} - {a}_{2} \cdot R )}{Z - {Z}_{O} - {c}_{2} \cdot R} \cdot {d}_{z 0} \cdot {c}_{3} + {X}_{O} + {a}_{2} \cdot R ;$$
$${Y}_{f} = \frac{( Y - {Y}_{O} - {a}_{2} \cdot R )}{Z - {Z}_{O} - {c}_{2} \cdot R} \cdot {d}_{z 0} \cdot {c}_{3} + {Y}_{O} + {a}_{2} \cdot R ;$$
in which X_{f}, Y_{f}, Z_{f} are components of the intersection point coordinate of the bundle adjustment collinear resection, (X_{O}, Y_{O}, Z_{O}) is the intersection point coordinate of the bundle adjustment co-spherical intersection, that is, world coordinate of the rotation center of the pan-tilt, d_{zO} and R are the structural parameters of the target vision measurement system;
the error equation is:
$${V}_{2} = {A}_{2} {X}_{2} - {L}_{2} ; wherein : \\ {V}_{2} = {[ {v}_{x} , {v}_{y} ]}^{T} ;$$
$${v}_{x} = {a}_{11} d {X}_{O} + {a}_{12} d {Y}_{O} + {a}_{13} d {Z}_{O} + {a}_{14} d ( {d}_{z 0} ) + {a}_{15} d R - {l}_{x} ;$$
$${v}_{y} = {a}_{21} d {X}_{O} + {a}_{22} d {Y}_{O} + {a}_{23} d {Z}_{O} + {a}_{24} d ( {d}_{z 0} ) + {a}_{25} d R - {l}_{y} ;$$
$${L}_{2} = {[ {l}_{x} , {l}_{y} ]}^{T} ;$$
$$\begin{matrix}{l}_{x} = {X}_{f} - ( {X}_{f} ) \\ = {X}_{f} + \frac{( X - {X}_{O} - {a}_{2} \cdot R )}{Z - {Z}_{O} - {c}_{2} \cdot R} \cdot {d}_{z 0} \cdot {c}_{3} + {X}_{O} + {a}_{2} \cdot R ;\end{matrix}$$
$$\begin{matrix}{l}_{y} = {Y}_{f} - ( {Y}_{f} ) \\ = {Y}_{f} + \frac{( Y - {Y}_{O} - {a}_{2} \cdot R )}{Z - {Z}_{O} - {c}_{2} \cdot R} \cdot {d}_{z 0} \cdot {c}_{3} + {Y}_{O} + {a}_{2} \cdot R ;\end{matrix}$$
$${A}_{2} = [ \begin{matrix}{a}_{11} & {a}_{12} & {a}_{13} & {a}_{14} & {a}_{15} \\ {a}_{21} & {a}_{22} & {a}_{23} & {a}_{24} & {a}_{25}\end{matrix} ] ;$$
$${X}_{2} = {[ \begin{matrix}d {X}_{O} & d {Y}_{O} & d {Z}_{O} & d ( {d}_{z 0} ) & d R\end{matrix} ]}^{T} ;$$
the normal equation is:
(A₂^{T}WA₂₎X₂=A₂^{T}WL₂;
then the solution to the normal equation is:
X₂₌₍A₂^{T}WA₂)⁻¹A₂^{T}WL₂;
in which W is an observation-value weight matrix that introduces systematic errors correction;
W=[(c₁₁X+c₁₂), (c₂₁Y+c₂₂), (c₃₁Z+c₃₂)];
in the equation, A₂ is a second observation matrix, W is the observation-value weighted matrix that introduces error correction components,
W=[c₁₁X+c₁₂), (c₂₁Y+c₂₂), (c₃₁Z+c₃₂)], wherein X, Y, Z represent the parametric variables of the front principal point of the tangent condition equation in the calculation of bundle tangent co-spherical intersection, c₁₁, c₁₂, c₃₁, c₂₂, c₃₁, c₃₂ represent compensation coefficients, X₂ is an incremental vector of the rotation center coordinate and the structural parameter, and L₂ is a linearized transformation vector of the tangent co-spherical condition equation;
the items in
$${A}_{2} = [ \begin{matrix}{a}_{11} & {a}_{12} & {a}_{13} & {a}_{14} & {a}_{15} \\ {a}_{21} & {a}_{22} & {a}_{23} & {a}_{24} & {a}_{25}\end{matrix} ]$$
are:
$$\begin{matrix}{a}_{11} = - \frac{{\partial }_{{X}_{f}}}{{\partial }_{{X}_{O}}} \\ = - \frac{{d}_{z 0} \cdot {c}_{3}}{Z - {Z}_{O} - {c}_{2} \cdot R} + 1 ;\end{matrix}$$
$${a}_{12} = - \frac{{\partial }_{{X}_{f}}}{{\partial }_{{Y}_{O}}} = 0 ;$$
$$\begin{matrix}{a}_{13} = - \frac{{\partial }_{{X}_{f}}}{{\partial }_{{Z}_{O}}} \\ = - ( X - {X}_{O} - {a}_{2} \cdot R ) \cdot ( {d}_{z 0} \cdot {c}_{3} ) \cdot \frac{1}{{( Z - {Z}_{O} - {c}_{2} \cdot R )}^{2}} ;\end{matrix}$$
$$\begin{matrix}{a}_{14} = - \frac{{\partial }_{{X}_{f}}}{{\partial }_{R}} \\ = \frac{\begin{matrix}{a}_{2} \cdot {d}_{z 0} \cdot {c}_{3} \cdot ( Z - {Z}_{O} - {c}_{2} \cdot R ) - \\ {c}_{2} \cdot {d}_{z 0} \cdot {c}_{3} \cdot ( X - {X}_{O} - {a}_{2} \cdot R )\end{matrix}}{{( Z - {Z}_{O} - {c}_{2} \cdot R )}^{2}} + a 2 ;\end{matrix}$$
$$\begin{matrix}{a}_{15} = - \frac{{\partial }_{{X}_{f}}}{{\partial }_{{d}_{z 0}}} \\ = - {c}_{3} \cdot \frac{X - {X}_{O} - {a}_{2} \cdot R}{Z - {Z}_{O} - {c}_{2} \cdot R} ;\end{matrix}$$
$${a}_{21} = - \frac{{\partial }_{{Y}_{f}}}{{\partial }_{{X}_{O}}} = 0 ;$$
$$\begin{matrix}{a}_{22} = - \frac{{\partial }_{{Y}_{f}}}{{\partial }_{{Y}_{O}}} \\ = - \frac{{d}_{z 0} \cdot {c}_{3}}{Z - {Z}_{O} - {c}_{2} \cdot R} + 1 ;\end{matrix}$$
$$\begin{matrix}{a}_{23} = - \frac{{\partial }_{{Y}_{f}}}{{\partial }_{{Z}_{O}}} \\ = - ( Y - {Y}_{O} - {a}_{2} \cdot R ) \cdot ( {d}_{z 0} \cdot {c}_{3} ) \cdot \frac{1}{{( Z - {Z}_{O} - {c}_{2} \cdot R )}^{2}} ;\end{matrix}$$
$$\begin{matrix}{a}_{24} = \frac{{\partial }_{{Y}_{f}}}{{\partial }_{R}} \\ = \frac{\begin{matrix}{b}_{2} \cdot {d}_{z 0} \cdot {c}_{3} \cdot ( Z - {Z}_{O} - {c}_{2} \cdot R ) - \\ {c}_{2} \cdot {d}_{z 0} \cdot {c}_{3} \cdot ( X - {X}_{O} - {a}_{2} \cdot R )\end{matrix}}{{( Z - {Z}_{O} - {c}_{2} \cdot R )}^{2}} + b 2 ;\end{matrix}$$
$$\begin{matrix}{a}_{25} = - \frac{{\partial }_{{Y}_{f}}}{{\partial }_{{d}_{z 0}}} \\ = - {c}_{3} \cdot \frac{Y - {Y}_{O} - {a}_{2} \cdot R}{Z - {Z}_{O} - {c}_{2} \cdot R} ;\end{matrix}$$
through iterative operation, acquiring the world coordinate O(X_{O}, Y_{O}, Z_{O}) of the intersection point of the rotation center in which systematic errors are corrected, and the structural parameters d_{z0} and R;
wherein the calculation process of performing the co-spherical second intersection and iterative operation includes:
establishing a world coordinate system of a two-dimensional calibration board, acquiring image coordinates of the principal points from an image plane, and performing systematic error correction of the image point coordinates using the matrix W;
calculating the world coordinates of the projected points of the principal points on the calibration board using the image coordinates of the principal point;
roughly estimating the initial values X_{O}⁰, Y_{O}⁰, Z_{O}⁰, d_{z0}⁰ and R⁰ based on the equipment conditions of an actual calibration experiment;
substituting the values of three angular elements with external orientation elements acquired from the first collinear intersection;
calculating the approximate value of each point in the F(X_{f}, Y_{f}, Z_{f}) point set point by point;
calculating the corrected numerical values dX_{O}, dY_{O}, dZ_{O} of spherical center coordinate and the corrected numerical values d(d_{z0})and dR of the structural parameters point by point;
calculating the value of the current iteration by adding the approximate values at the previous iteration to the corrected numerical values:
X_{O}ⁱ=X_{O}¹⁻¹dX_{O}ⁱ; Y_{O}ⁱY_{O}ⁱ⁻¹+dy_{O}ⁱ; Z_{O}ⁱZ_{O}ⁱ⁻¹+dZ_{O}ⁱ; d_{z0}ⁱ=d_{z0}ⁱ⁻¹+d(d_{z0}ⁱ); Rⁱ=Rⁱ⁻¹+dRⁱ;
comparing the corrected numerical values dX_{O}, dY_{O}, dZ_{O} of the calculated spherical center coordinates and the corrected numerical values d(d_{z0}) and dR of the calculated structural parameters with a predetermined tolerance, allowing the iteration to end if the precision is reached, and then outputting the spherical center coordinate O (X_{O}, Y_{O}, Z_{O}) and the structural parameters d_{z0} and R.

10. The system according to claim 7, wherein the affine space coordinate system construction module is specifically configured to:
by taking the rotation center O of the pan-tilt or hand-eye system as the coordinate origin, to set the given fixed focus fᵢ and the structural parameters d_{z0}ⁱ and rotating structural parameters R as the focal point coordinate of initial point F₀, rotate the pan-tilt, with the rotation matrix being:
$$[ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] ;$$
acquire the coordinate of F₁ as:
$$[ \begin{matrix}{X}_{f 1} \\ {Y}_{f 1} \\ {Z}_{f 1}\end{matrix} ] = [ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] \cdot [ \begin{matrix}{X}_{f 0} \\ {Y}_{f 0} \\ {Z}_{f 0}\end{matrix} ] ;$$
still taking the rotation center O as the origin, continue to rotate, with the rotation of the pan-tilt, establish the affine coordinate systems of different angles of view in sequence, so as to realize the vision measurement of multi-angle uncalibrated front intersection.

11. The method according to claim 3, wherein the step of S3 further comprises:
traversing all the calibrated images, performing steps S1 and S2 cyclically, acquiring an F(X_{f}, Y_{f}, Z_{f}) point set of the intersection point coordinates, and a corresponding world coordinate A(X, Y, Z) point set of the front projection points in which systematic errors are corrected.

12. The method according to claim 11, wherein the step of S4 further comprises:
taking each pair of corresponding points in the F(X_{f}, Y_{f}, Z_{f}) point set of the intersection point coordinates acquired in one intersection and the world coordinate A(X, Y, Z) point set of the front projection points as a group of corresponding projection points, which respectively correspond to a corresponding point in a space point set P in pairs, establishing a tangent co-spherical condition equation; F(X_{f}, Y_{f}, Z_{f}) and P are each a co-spherical point set, straight line AFP is a tangent line of a sphere P with P being the tangent point; performing co-spherical second intersection with A, F and P, and acquiring a world coordinate O(X_{O}, Y_{O}, Z_{O}) of the intersection point of the rotation center through iterative operation, meanwhile solving structural parameters d_{z0} and R;
acquiring a corresponding vector \vec{(OP)ᵢ} of each Fᵢ in F(X_{f}, Y_{f}, Z_{f}) by the rotation of vector \vec{OP}, and a rotation matrix from \vec{OP} to \vec{(OP)ᵢ} being
$$[ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] ;$$
the tangent equation of the three points A, F and P being:
$$\frac{X - {X}_{p}}{{X}_{f} - {X}_{p}} = \frac{Y - {Y}_{p}}{{Y}_{f} - {Y}_{p}} = \frac{Z - {Z}_{p}}{{Z}_{f} - {Z}_{p}} = \frac{1}{λ} ;$$
the solution being:
$${X}_{f} = \frac{( X - {X}_{O} - {a}_{2} \cdot R )}{Z - {Z}_{O} - {c}_{2} \cdot R} \cdot {d}_{z 0} \cdot {c}_{3} + {X}_{O} + {a}_{2} \cdot R ;$$
$${Y}_{f} = \frac{( Y - {Y}_{O} - {a}_{2} \cdot R )}{Z - {Z}_{O} - {c}_{2} \cdot R} \cdot {d}_{z 0} \cdot {c}_{3} + {Y}_{O} + {a}_{2} \cdot R ;$$
in which X_{f}, Y_{f}, Z_{f} are components of the intersection point coordinate of the bundle adjustment collinear resection, (X_{O}, Y_{O}, Z_{O}) is the intersection point coordinate of the bundle adjustment co-spherical intersection, that is, world coordinate of the rotation center of the pan-tilt, d_{z0} and R are the structural parameters of the target vision measurement system;
the error equation is:
$${V}_{2} = {A}_{2} {X}_{2} - {L}_{2} ; wherein : \\ {V}_{2} = {[ {v}_{x} , {v}_{y} ]}^{T} ;$$
$${v}_{x} = {a}_{11} d {X}_{O} + {a}_{12} d {Y}_{O} + {a}_{13} d {Z}_{O} + {a}_{14} d ( {d}_{z 0} ) + {a}_{15} d R - {l}_{x} ;$$
$${v}_{y} = {a}_{21} d {X}_{O} + {a}_{22} d {Y}_{O} + {a}_{23} d {Z}_{O} + {a}_{24} d ( {d}_{z 0} ) + {a}_{25} d R - {l}_{y} ;$$
$${L}_{2} = {[ {l}_{x} , {l}_{y} ]}^{T} ;$$
$$\begin{matrix}{l}_{x} = {X}_{f} - ( {X}_{f} ) \\ = {X}_{f} + \frac{( X - {X}_{O} - {a}_{2} \cdot R )}{Z - {Z}_{O} - {c}_{2} \cdot R} \cdot {d}_{z 0} \cdot {c}_{3} + {X}_{O} + {a}_{2} \cdot R ;\end{matrix}$$
$$\begin{matrix}{l}_{y} = {Y}_{f} - ( {Y}_{f} ) \\ = {Y}_{f} + \frac{( Y - {Y}_{O} - {a}_{2} \cdot R )}{Z - {Z}_{O} - {c}_{2} \cdot R} \cdot {d}_{z 0} \cdot {c}_{3} + {Y}_{O} + {a}_{2} \cdot R ;\end{matrix}$$
$${A}_{2} = [ \begin{matrix}{a}_{11} & {a}_{12} & {a}_{13} & {a}_{14} & {a}_{15} \\ {a}_{21} & {a}_{22} & {a}_{23} & {a}_{24} & {a}_{25}\end{matrix} ] ;$$
$${X}_{2} = {[ \begin{matrix}d {X}_{O} & d {Y}_{O} & d {Z}_{O} & d ( {d}_{z 0} ) & d R\end{matrix} ]}^{T} ;$$
the normal equation is:
(A₂^{T}WA₂₎X₂=A₂^{T}WL₂;
the solution to the normal equation is:
X₂₌₍A₂^{T}WA₂)⁻¹A₂^{T}WL₂;
in which Wis an observation-value weight matrix that introduces systematic errors correction;
W=[(c₁₁X+c₁₂), (c₂₁Y+c₂₂), (c₃₁Z+c₃₂)];
in the equation, A₂ is a second observation matrix, W is the observation-value weight matrix that introduces error correction components,
W=[c₁₁X+c₁₂), (c₂₁Y+c₂₂), (c₃₁Z+c₃₂)], wherein X, Y, Z represent the parametric variables of the front principal point of the tangent condition equation in the calculation of bundle tangent co-spherical intersection, c₁₁, c₁₂, c₃₁, c₂₂, c₃₁, c₃₂ represent compensation coefficients, X₂ is an incremental vector of the rotation center coordinate and the structural parameters, and L₂ is a linearized transformation vector of the tangent co-spherical condition equation;
the items in
$${A}_{2} = [ \begin{matrix}{a}_{11} & {a}_{12} & {a}_{13} & {a}_{14} & {a}_{15} \\ {a}_{21} & {a}_{22} & {a}_{23} & {a}_{24} & {a}_{25}\end{matrix} ]$$
are:
$$\begin{matrix}{a}_{11} = - \frac{{\partial }_{{X}_{f}}}{{\partial }_{{X}_{O}}} \\ = - \frac{{d}_{z 0} \cdot {c}_{3}}{Z - {Z}_{O} - {c}_{2} \cdot R} + 1 ;\end{matrix}$$
$${a}_{12} = - \frac{{\partial }_{{X}_{f}}}{{\partial }_{{Y}_{O}}} = 0 ;$$
$$\begin{matrix}{a}_{13} = - \frac{{\partial }_{{X}_{f}}}{{\partial }_{{Z}_{O}}} \\ = - ( X - {X}_{O} - {a}_{2} \cdot R ) \cdot ( {d}_{z 0} \cdot {c}_{3} ) \cdot \frac{1}{{( Z - {Z}_{O} - {c}_{2} \cdot R )}^{2}} ;\end{matrix}$$
$$\begin{matrix}{a}_{14} = - \frac{{\partial }_{{X}_{f}}}{{\partial }_{R}} \\ = \frac{\begin{matrix}{a}_{2} \cdot {d}_{z 0} \cdot {c}_{3} \cdot ( Z - {Z}_{O} - {c}_{2} \cdot R ) - \\ {c}_{2} \cdot {d}_{z 0} \cdot {c}_{3} \cdot ( X - {X}_{O} - {a}_{2} \cdot R )\end{matrix}}{{( Z - {Z}_{O} - {c}_{2} \cdot R )}^{2}} + a 2 ;\end{matrix}$$
$$\begin{matrix}{a}_{15} = - \frac{{\partial }_{{X}_{f}}}{{\partial }_{{d}_{z 0}}} \\ = - {c}_{3} \cdot \frac{X - {X}_{O} - {a}_{2} \cdot R}{Z - {Z}_{O} - {c}_{2} \cdot R} ;\end{matrix}$$
$${a}_{21} = - \frac{{\partial }_{{Y}_{f}}}{{\partial }_{{X}_{O}}} = 0 ;$$
$$\begin{matrix}{a}_{22} = - \frac{{\partial }_{{Y}_{f}}}{{\partial }_{{Y}_{O}}} \\ = - \frac{{d}_{z 0} \cdot {c}_{3}}{Z - {Z}_{O} - {c}_{2} \cdot R} + 1 ;\end{matrix}$$
$$\begin{matrix}{a}_{23} = - \frac{{\partial }_{{Y}_{f}}}{{\partial }_{{Z}_{O}}} \\ = - ( Y - {Y}_{O} - {a}_{2} \cdot R ) \cdot ( {d}_{z 0} \cdot {c}_{3} ) \cdot \frac{1}{{( Z - {Z}_{O} - {c}_{2} \cdot R )}^{2}} ;\end{matrix}$$
$$\begin{matrix}{a}_{24} = \frac{{\partial }_{{Y}_{f}}}{{\partial }_{R}} \\ = \frac{\begin{matrix}{b}_{2} \cdot {d}_{z 0} \cdot {c}_{3} \cdot ( Z - {Z}_{O} - {c}_{2} \cdot R ) - \\ {c}_{2} \cdot {d}_{z 0} \cdot {c}_{3} \cdot ( X - {X}_{O} - {a}_{2} \cdot R )\end{matrix}}{{( Z - {Z}_{O} - {c}_{2} \cdot R )}^{2}} + b 2 ;\end{matrix}$$
$$\begin{matrix}{a}_{25} = - \frac{{\partial }_{{Y}_{f}}}{{\partial }_{{d}_{z 0}}} \\ = - {c}_{3} \cdot \frac{Y - {Y}_{O} - {a}_{2} \cdot R}{Z - {Z}_{O} - {c}_{2} \cdot R} ;\end{matrix}$$
through iterative operation, acquiring the world coordinate O(X_{O}, Y_{O}, Z_{O}) of the intersection point of the rotation center in which systematic errors are corrected, and the structural parameters d_{z0} and R;
wherein the calculation process of performing the co-spherical second intersection and iterative operation includes:
establishing a world coordinate system of a two-dimensional calibration board, acquiring image coordinates of the principal points from an image plane, and performing systematic error correction on the image point coordinates using the matrix W;
calculating the world coordinates of the projected points of the principal points on the calibration board using the image coordinates of the principal points;
roughly estimating the initial values X_{O}⁰, Y_{O}⁰, Z_{O}⁰, d_{z0}⁰ and R⁰ based on equipment conditions of an actual calibration experiment;
substituting the values of three angular elements with external orientation elements acquired from the first collinear intersection;
calculating the approximate value of each point in the F(X_{f}, Y_{f}, Z_{f}) point set point by point;
calculating the corrected numerical values dX_{O}, dY_{O}, dZ_{O} of spherical center coordinate and the corrected numerical values d(d_{z0})and dR of the structural parameters point by point;
calculating the values of the current iteration by adding approximate values at the previous iteration to the corrected numerical values:
X_{O}ⁱ=X_{O}ⁱ⁻¹+dX_{O}ⁱ; Y_{O}ⁱY_{O}ⁱ⁻¹+dY_{O}ⁱ; Z_{O}ⁱ=Z_{O}ⁱ⁻¹+dZ_{O}ⁱ; d_{z0}ⁱ=d_{z0}ⁱ⁻¹+d(d_{z0}ⁱ); Rⁱ=Rⁱ⁻¹+dRⁱ;
comparing the corrected numerical values dX_{O}, dY_{O}, dZ_{O}of the calculated spherical center coordinates and the corrected numerical values d(d_{z0}) and dR of the calculated structural parameters with a predetermined tolerance, allowing the iteration to end if the precision is reached, and then outputting the spherical center coordinate O(X_{O}, Y_{O}, Z_{O}) and the structural parameters d_{z0} and R.

13. The method according to claim 12, wherein the step of S5 further comprises:
taking the rotation center O of the pan-tilt or hand-eye system as the coordinate origin, to set the given fixed focus fᵢ and the structural parameters d_{z0}ⁱ and rotating structural parameters R as the focal point coordinate of initial point F₀, rotating the pan-tilt, with the rotation matrix being:
$$[ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] ;$$
acquiring the coordinate of F₁ as:
$$[ \begin{matrix}{X}_{f 1} \\ {Y}_{f 1} \\ {Z}_{f 1}\end{matrix} ] = [ \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ] \cdot [ \begin{matrix}{X}_{f 0} \\ {Y}_{f 0} \\ {Z}_{f 0}\end{matrix} ] ;$$
still taking the rotation center O as the origin, continuing to rotate, with the rotation of the pan-tilt, establishing the affine coordinate systems of different angles of view in sequence, so as to realize the vision measurement of multi-angle uncalibrated front intersection.
